(19) United States
(12) Patent Application Publication
(10) Pub. No.: US 2006/0170739 A1
(43) Pub. Date: Aug. 3, 2006

(54) Ink-Jet Recording Apparatus

(75) Inventors: Yuji Koga, Nagoya-shi, Aichi-ken (JP); Takatoshi Takemoto, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi, Aichi-ken, (JP)

(21) Appl. No.: 11/275,844

(22) Filed: Jan. 31, 2006

(30) Foreign Application Priority Data
Jan. 31, 2005 (JP) 200524424

(51) Int. Cl. B41J 2/175

(52) U.S. Cl. 347/85

(57) ABSTRACT

An ink-jet recording apparatus is provided which can be composed of fewer number of parts and easily controlled. In the ink-jet recording apparatus, one pressurized unit such as a pressurized pump for ink supply is used. An open/close state switching member which opens/closes an air communication hole of a sub-tank is integrally formed with an ink supply member which supplies ink within a main tank to the sub-tank. Accordingly, depending on a relative position between the ink supply member and the sub-tank, the operation mode is easily switched to at least following three modes: recording mode, ink supply mode (standby mode), and discharge performance recovery mode.

### CROSS-REFERENCE TO RELATED APPLICATIONS

This application claims the benefit of Japanese Patent Application No. 2005-24424 filed Jan. 31, 2005 in the Japan Patent Office, the disclosure of which is incorporated herein by reference.

### BACKGROUND

This invention relates to a technique for providing an ink-jet recording apparatus that can be composed of fewer number of parts and easily controlled.

Heretofore, an ink-jet recording apparatus is known to include a stationary ink supply system. That is, this type of ink-jet recording apparatus is provided with a carriage with a recording head and an ink tank mounted thereon, and a main tank storing ink supplied to the ink tank. The recording head ejects ink from an injection nozzle to perform recording onto a recording media, and the ink tank stores ink supplied to the recording head. When the ink in the ink tank is decreased, ink in the main tank is supplied to a sub-tank (ink tank).

Among the aforementioned ink-jet recording apparatus, there is one which is designed to supply ink from the main tank by reducing pressure inside the ink tank mounted on the carriage. Particularly, such an ink-jet recording apparatus includes a recording head carriage (hereinafter, referred to as a carriage) with a recording head and a sub-ink tank for storing ink supplied to the recording head mounted thereon, a main tank for storing ink supplied to the ink tank, and an ink refiller. Among the aforementioned components, the sub-ink tank mounted on the carriage includes a refill port for receiving an ink refill from the main tank, an exhaust port for discharging air inside the sub-ink tank, and an air communication hole for communicating the inside of the sub-ink tank with the atmosphere. On the other hand, the ink refiller includes a refill port for supplying ink stored in the main tank to the sub-ink tank when connected to the refill port of the sub-ink tank, an exhaust port for connecting to the exhaust port of the sub-ink tank, a pump unit that reduces pressure inside the sub-ink tank through the exhaust port, and a cap that seals the air communication hole of the sub-ink tank when the cap abuts the air communication hole. The ink refiller is designed capable of changing its relative position to the carriage by a moving mechanism. When ink is supplied from the main tank to the sub-ink tank, the ink refiller is moved toward the carriage by the moving mechanism so that the refill port of the sub-ink tank is connected to the refill port of the ink refiller and the exhaust port of the sub-ink tank is connected to the exhaust port of the ink refiller. Also, the air communication hole of the sub-ink tank is sealed by the cap of the ink refiller. When the pump unit of the ink refiller reduces pressure inside the sub-ink tank through the exhaust ports of the ink refiller and of the sub-ink tank, since the air communication hole of the sub-ink tank is sealed by the cap of the ink refiller, the ink stored in the sub-ink tank is supplied into the sub-ink tank through the refill ports of the ink refiller and of the sub-ink tank.

### SUMMARY

However, in the aforementioned ink-jet recording apparatus, ink is supplied from the main tank by reducing pressure inside the ink tank mounted on the carriage by the pump unit. Thus, the pump unit is disposed on a downstream side in the ink supply passage. In this case, for example, an exhaust port of the sub-ink tank and an exhaust port of the ink refiller are necessary. There are problems in which the number of parts is increased and the control of the aforementioned respective components becomes complex.

The present invention is made to solve the above problems. It would be desirable to provide an ink-jet recording apparatus that can be composed of fewer number of parts and easily controlled.

One aspect of the present invention provides an ink-jet recording apparatus including: a recording head, a carriage, a main tank, an ink supply member, and a relative position changer. The recording head has an internal sub-tank for storing ink, and records an image on a recording medium by selectively ejecting ink inside the sub-tank from an injection nozzle. The carriage has the recording head mounted thereon, and can move to and fro in a direction orthogonal to a conveying direction of the recording medium. The main tank stores ink supplied to the sub-tank. The ink supply member supplies ink inside the main tank to the sub-tank. The relative position changer can change a relative position between the ink supply member and the sub-tank. The sub-tank includes an ink supply opening which can be attached to/detached from the ink supply member and through which the ink inside of the main tank is supplied, and an air communication hole that communicates the inside of the sub-tank with the atmosphere. The ink supply member includes an ink supply nozzle that can be attached to/detached from the ink supply opening, and an open/close state switching member that switches an open/close state of the air communication hole. The ink-jet recording apparatus further includes a pressurized unit that applies pressure to the ink inside the main tank so as to deliver the ink inside the main tank to the ink supply member, and a relative position controller that controls the relative position changer to switch an operation mode of the ink-jet recording apparatus to at least following three modes: (a) a recording mode in which the ink supply opening and the ink supply nozzle are separated and the air communication hole is in an open state so that recording of an image on the recording medium is enabled; (b) an ink supply mode in which the ink supply opening is connected to the ink supply nozzle and the air communication hole is in an open state so that ink is supplied to the sub-tank by pressure applied by the pressurized unit; and (c) a discharge performance recovery mode in which the ink supply opening and the ink supply nozzle are closely connected and the air communication hole is in a closed state so that discharge performance of the recording head is recovered by the pressure applied by the pressurized unit.

### BRIEF DESCRIPTION OF THE DRAWINGS

The invention will now be described below, by way of example, with reference to the accompanying drawings, in which:

FIG. 1 is a perspective view of a multifunctional apparatus including a printing function, a copying function, a scanner function, a facsimile function, and a telephone function;

FIG. 2 is an explanatory view showing a schematic internal structure of a printer provided in the multifunctional apparatus;

FIG. 3 is a block diagram showing a schematic structure of a control processor;

FIG. 4 is an explanatory view showing a schematic structure of a recording head and an ink supply mechanism according to a first embodiment;

FIG. 5A is an explanatory view showing the recording head and the ink supply mechanism according to the first embodiment during ink supply and during standby;

FIG. 5B is an explanatory view showing the recording head and the ink supply mechanism according to the first embodiment during positive pressure purge;

FIG. 5C is a table showing an open/close state of an air communication hole and an ink supply opening according to the first embodiment;

FIG. 6 is an explanatory view showing a schematic structure of a recording head and an ink supply mechanism according to a second embodiment;

FIG. 7A is an explanatory view showing the recording head and the ink supply mechanism according to the second embodiment during long-term storage;

FIG. 7B is an explanatory view showing the recording head and the ink supply mechanism according to the second embodiment during ink supply and during standby;

FIG. 7C is an explanatory view showing the recording head and the ink supply mechanism according to the second embodiment during positive pressure purge;

FIG. 7D is a table showing an open/close state of the air communication hole and the ink supply opening according to the second embodiment;

FIG. 8 is an explanatory view showing a schematic structure of a recording head and an ink supply mechanism according to a third embodiment;

FIG. 9A is an explanatory view showing the recording head and the ink supply mechanism according to the third embodiment during ink supply and during standby;

FIG. 9B is an explanatory view showing the recording head and the ink supply mechanism according to the third embodiment during positive pressure purge;

FIG. 9C is a table showing an open/close state of the air communication hole and the ink supply opening according to the third embodiment;

FIG. 10 is an explanatory view showing a schematic structure of a recording head and an ink supply mechanism according to a fourth embodiment;

FIG. 11A is an explanatory view showing the recording head and the ink supply mechanism according to the fourth embodiment during long-term storage;

FIG. 11B is an explanatory view showing the recording head and the ink supply mechanism according to the fourth embodiment during ink supply and during standby;

FIG. 11C is an explanatory view showing the recording head and the ink supply mechanism according to the fourth embodiment during positive pressure purge;

FIG. 11D is a table showing an open/close state of the air communication hole and the ink supply opening according to the fourth embodiment;

FIG. 12 is an explanatory view showing a schematic structure of a recording head and an ink supply mechanism according to a fifth embodiment,

FIG. 13A is an explanatory view showing the recording head and the ink supply mechanism according to the fifth embodiment during ink supply and during standby;

FIG. 13B is an explanatory view showing the recording head and the ink supply mechanism according to the fifth embodiment during positive pressure purge;

FIG. 13C is a table showing an open/close state of the air communication hole and the ink supply opening according to the fifth embodiment;

FIG. 14 is an explanatory view showing a schematic structure of a recording head and an ink supply mechanism according to a sixth embodiment;

FIG. 15A is an explanatory view showing the recording head and the ink supply mechanism according to the sixth embodiment during ink supply and during standby;

FIG. 15B is an explanatory view showing the recording head and the ink supply mechanism according to the sixth embodiment during positive pressure purge;

FIG. 15C is a table showing an open/close state of the air communication hole and the ink supply opening according to the sixth embodiment;

FIG. 16 is an explanatory view showing a schematic structure of a recording head and an ink supply mechanism according to a seventh embodiment;

FIG. 17A is an explanatory view showing the recording head and the ink supply mechanism according to the seventh embodiment during long-term storage;

FIG. 17B is an explanatory view showing the recording head and the ink supply mechanism according to the seventh embodiment during ink supply and during standby;

FIG. 18A is an explanatory view showing the recording head and the ink supply mechanism according to the seventh embodiment during positive pressure purge; and

FIG. 18B is a table showing an open/close state of the air communication hole and the ink supply opening according to the seventh embodiment.

### DETAILED DESCRIPTION OF THE PREFERRED EMBODIMENT

### First Embodiment

In the present embodiment, the invention is applied to a multifunctional apparatus provided with a printer function, a copying function, a scanner function, a facsimile function, and a phone function.

[Description of Multifunctional Apparatus 1]

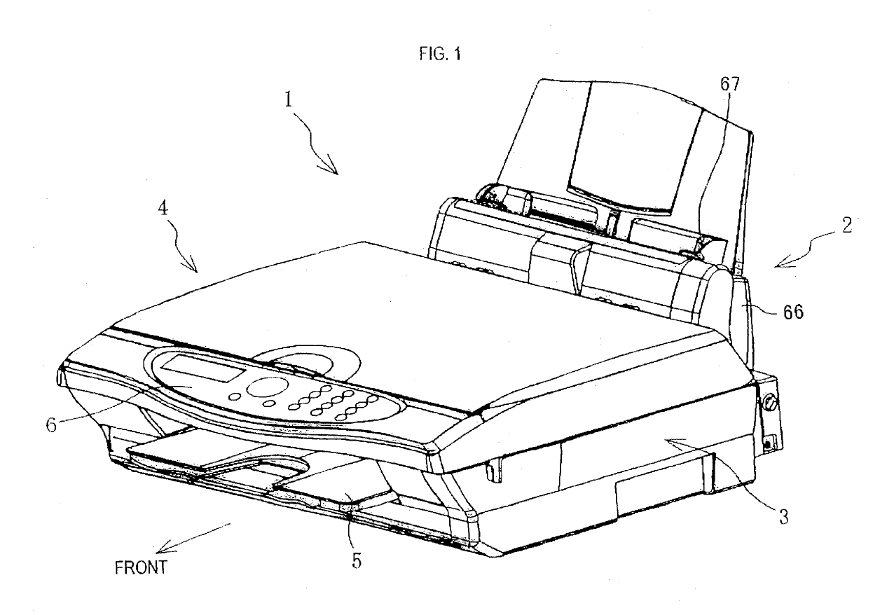

Referring to FIG. 1, a multifunctional apparatus 1 is provided with a feeding device 2 at a rear end portion. On the front side below the feeding device 2, an ink-jet printer 3 is provided. On top of the printer 3, a reader 4 for the copying function and facsimile function is provided. A discharge tray 5 is provided on the front side of the printer 3. An operation panel 6 is provided on the upper face at the front end of the reader 4.

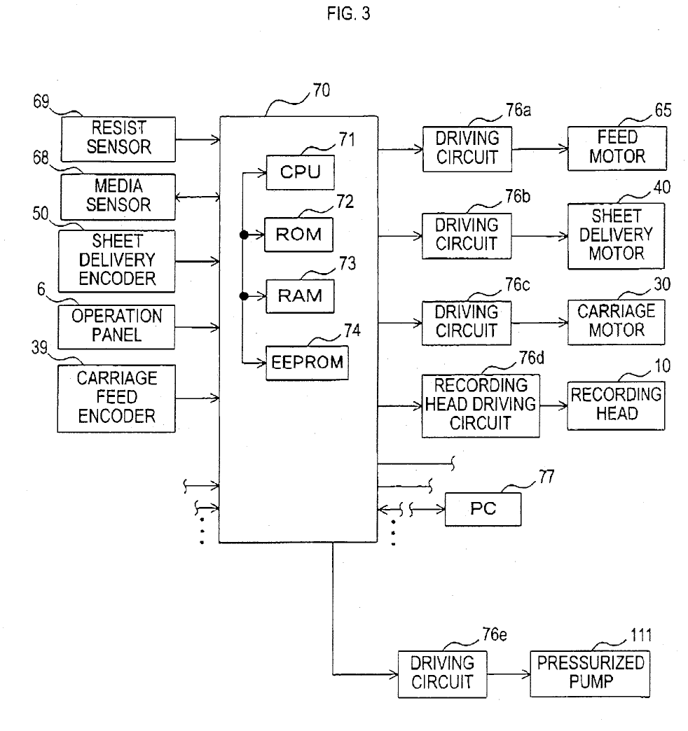

The feeding device 2 includes a slant wall 66 that retains a sheet at a slanted attitude, and an expanded sheet guide board 67 that is detachably attached to the slant wall 66. A plurality of sheets can be loaded on the feeding device 2. The slant wall 66 internally includes a feed motor 65 (see FIG. 3) and a feed roller (not shown). The feed roller rotates by the driving force of the feed motor 65 and delivers a sheet toward the printer 3.

[Description of Printer 3]

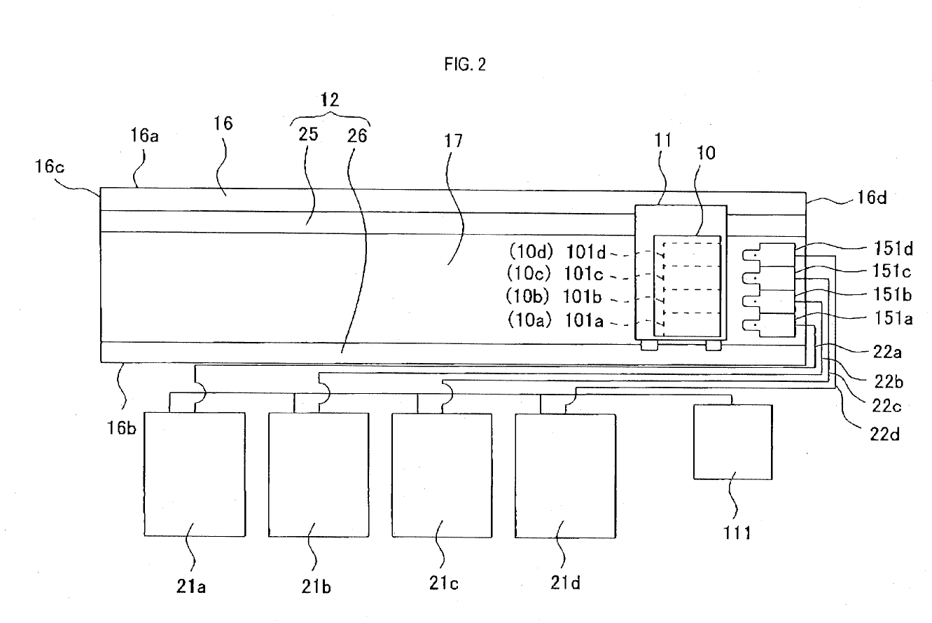

Now, the structure of the printer 3 is described by way of FIG. 2. FIG. 2 is a schematic diagram of the internal structure of the printer 3.

As shown in FIG. 2, the printer 3 includes a recording head 10, a carriage 11, a guide mechanism 12, a carriage moving mechanism (not shown), a sheet delivery mechanism (not shown), and a maintenance mechanism (not shown) for the recording head 10. The guide mechanism 12 holds the carriage 11 with the recording head 10 mounted thereon in such a manner that the carriage 11 can move in a horizontal direction or a main scanning direction. The carriage moving mechanism moves the carriage 11 in the horizontal direction. The sheet delivery mechanism delivers a sheet fed from the feeding device 2

The printer 3 is also provided with a frame 16 of a rectangular parallelepiped. The frame 16 is long in the horizontal direction and short in the vertical direction. The guide mechanism 12, the carriage moving mechanism, the sheet delivery mechanism, and the maintenance mechanism are all attached to the frame 16. Moreover, the recording head 10 and the carriage 11 are accommodated inside the frame 16 in a manner capable of moving in the horizontal direction.

Inlet and outlet (not shown) for the sheet are respectively formed on the rear and front side boards 16a, 16b of the frame 16. The sheet supplied by the feeding device 2 is guided into the frame 16 from the inlet. The sheet is then delivered forward by the sheet delivery mechanism and discharged from the outlet to the discharge tray 5 (see FIG. 1) located further ahead. Also, a black platen 17, having a plurality of ribs, is attached to the bottom portion of the frame 16. Inside the frame 16, recording (image forming) by the recording head 10 is performed on the sheet being moved across the platen 17.

Four color ink cartridges 21a to 21d are attached to a cartridge attachment portion (not shown) on the front side of the frame 16. The cartridges 21a to 21d are respectively connected to ink supply mechanisms 151a to 151d, disposed in the vicinity of the right end of the frame 16, via four flexible ink tubes 22a to 22d that pass through the inside of the frame 16.

Two horizontally-arranged FPCs (flexible print circuits, not shown) are installed inside the frame 16. The FPCs extend to and are connected to the recording head 10. The two horizontally-arranged FPCs include wiring of a plurality of signal lines that electrically connect a later-explained control processor 70 (see FIG. 3) and the recording head 10.

The guide mechanism 12 has a guide shaft 25 and a guide rail 26. The guide shaft 25 is laid along the horizontal direction at the rear portion inside the frame 16. Both ends of the guide shaft 25 are respectively connected to a left side board 16c and a right side board 16d of the frame 16. The guide rail 26 is formed at the front portion inside the frame 16 and extends along the horizontal direction. The rear end portion of the carriage 11 slidably fits onto the guide shaft 25, while the front end portion of the carriage 11 slidably engages with the guide rail 26.

The carriage moving mechanism is provided with a carriage motor 30 (see FIG. 3) and a belt mechanism (not shown). The belt mechanism transmits the driving force of the carriage motor 30 to the carriage 11. The carriage moving mechanism is driven and controlled by the later-explained control processor 70 (see FIG. 3). That is, the carriage 11 is driven via the belt mechanism by the driven carriage motor 30.

The sheet delivery mechanism is provided with a sheet delivery motor 40 (see FIG. 3), a resist roller (not shown), a discharge roller (not shown), and a belt mechanism (not shown) for transmitting the driving force of the sheet delivery motor 40 to the resist roller and the discharge roller. The sheet delivery mechanism is driven and controlled by the later-explained control processor 70 (see FIG. 3). Particularly, the sheet delivery mechanism includes a sheet delivery encoder 50. Based on the detection signal from the sheet delivery encoder 50 (more particularly, a photo interrupter), the later-explained control processor 70 drives and controls the sheet delivery motor 40. The resist roller is rotated via the belt mechanism by the driven sheet delivery motor 40 so that the sheet is delivered to and fro or discharged to the discharge tray 5 located ahead.

The maintenance mechanism includes a wiper (not shown), two caps (not shown), and a drive motor (not shown). The wiper wipes off the head face of the recording head 10. Each of the two caps can seal two out of four ink nozzle groups 10a to 10d. The drive motor drives both the wiper and the caps. The wiper, the caps, and the drive motor are attached to an attachment board (not shown) fixed on the undersurface at the right portion of the bottom board of the frame 16.

A media sensor 68 (see FIG. 3) is disposed at the left end portion of the recording head 10 as viewed in FIG. 2. The media sensor 68 is provided as a downstream sensor that can detect a front edge, a rear edge, and side edges in a width direction of a sheet. The media sensor 68 is a reflective type optical sensor including a light-emitter (light-emitting element) and a light-receiver (light-receiving element). The media sensor 68 is attached downward to a sensor attachment portion which protrudes leftward of the recording head 10.

On the upstream side (i.e., rear side) in the sheet delivery direction of the media sensor 68, a resist sensor 69 (see FIG. 3) is provided as an upstream sensor that can detect the presence/absence of the sheet, or the front edge and rear edge of the sheet. Particularly, the resist sensor 69 is attached to the front end portion of an upper cover that forms a delivery path for the feeding device 2.

The resist sensor 69 can be constituted, for example, from a detector, a photo interrupter, and a mechanical sensor. The detector protrudes into the sheet delivery path and is rotated when the sheet being delivered abuts the detector. The photo interrupter includes a light-emitter and a light-receiver, and detects rotation of the detector. The mechanical sensor has a torsion spring that biases the detector to the side of the sheet delivery path. Shielding is provided integrally with the detector. When the detector is rotated by the sheet being delivered, the shielding is disposed in a region other than between the light-emitter and the light-receiver of the photo interrupter. Then, the light transmission from the light-emitter to the light-receiver is performed, and the resist sensor 69 turns to an ON state. When the sheet is not delivered, the detector is biased to the side of the sheet delivery path by the torsion spring. The shielding is disposed between the light-emitter and the light-receiver of the photo interrupter. Accordingly, light transmission from the light-emitter to the light-receiver is interrupted, and the resist sensor 69 turns to an OFF state.

[Description of Recording Head 10]

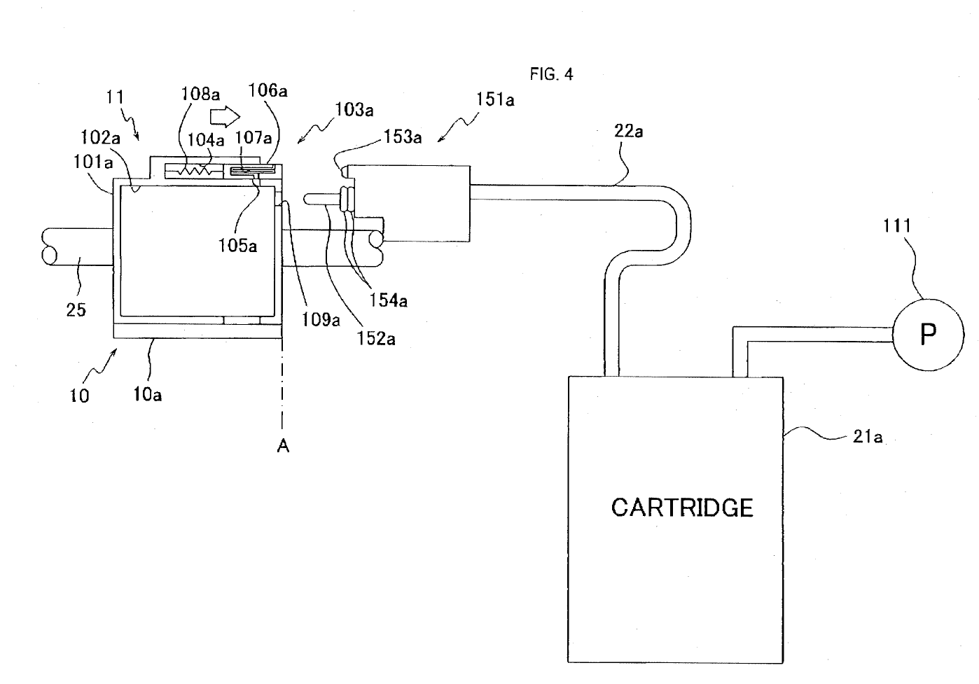

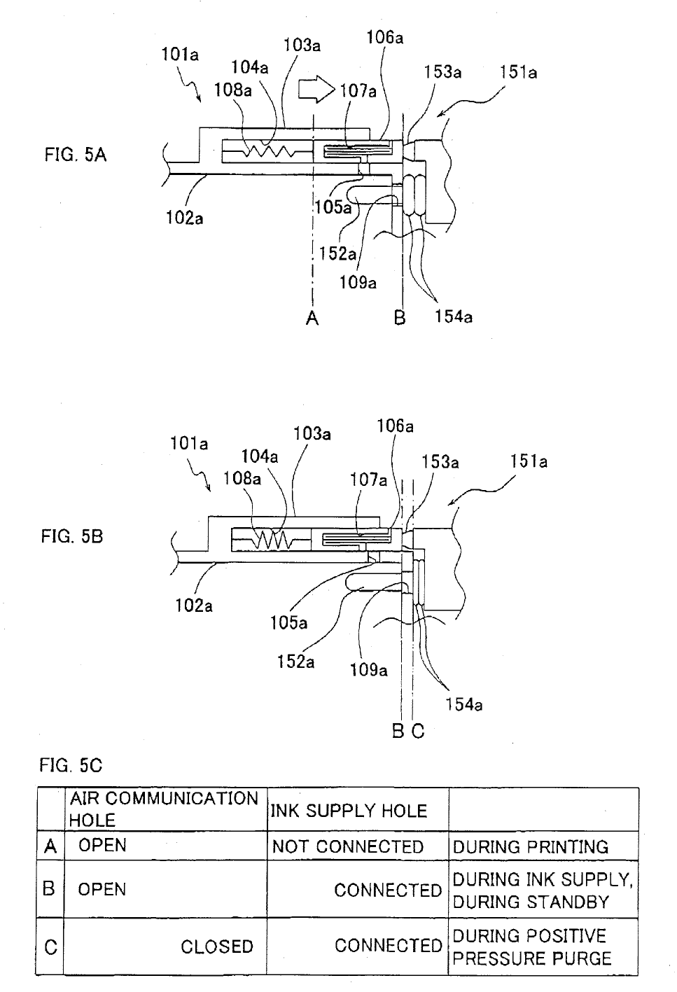

The structure of the recording head 10 provided in the printer 3 is described hereafter by way of FIGS. 4 and 5A to 5C.

Referring to FIG. 2, the recording head 10 includes the four ink nozzle groups 10a to 10d installed facing downward. From the ink nozzle groups 10a to 10d, four colors of ink (black, cyan, yellow, magenta) are ejected downward so that a recording is made onto the sheet.

Each of the ink nozzle groups 10a to 10d is constituted from ink nozzles (not shown) that eject an ink of a single color arranged in the sheet delivery direction. The ink nozzle groups 10a to 10d are arranged in order in the moving direction of the carriage 11. For example, each ink nozzle group is composed of 150 ink nozzles.

The recording head 10 has internal sub-tanks 101a to 101d, each of which stores one of the four colors of ink. These sub-tanks 101a to 101d and the ink nozzle groups 10a to 10d are connected via a tube or the like per color so that the ink of the respective colors can be supplied from the sub-tanks 101a to 101d to the ink nozzle groups 10a to 10d.

The sub-tanks 101a to 101d are the same in structure. Therefore, in the following description, only the structure of the sub-tank 101a for one specific color of ink will be explained in detail. Descriptions of the sub-tanks 101b to 101d for the other colors of ink are arbitrarily omitted. The same applies to the ink nozzle groups 10a to 10b, the ink cartridges 21a to 21d, the ink tubes 22a to 22d, and the ink supply mechanisms 151a to 151d.

Referring to FIG. 4, the sub-tank 101a is provided with a tank body 102a for storing ink, and an exhaust portion 103a for discharging the air inside the tank body 102a to the outside. The exhaust portion 103a includes a cavity portion 104a, an air communication hole 105a, a slider 106a, and a spring device 108a. The cavity portion 104a is formed on top of the recording head 10 and opens rightward. The air communication hole 105a communicates the tank body 102a with the atmosphere via the cavity portion 104a. At least a part of the slider 106a is disposed inside the cavity portion 104a. The slider 106a opens/closes the air communication hole 105a.

The cavity portion 104a is arranged to face a switching member 153a of the ink supply mechanism 151a. The cavity portion 104a communicates with the tank body 102a via the air communication hole 105a. Accordingly, the tank body 102a is communicated with the atmosphere via the cavity portion 104a and the air communication hole 105a.

The slider 106a can be moved in the horizontal direction inside the cavity portion 104a. The slider 106a is pressed rightward by the spring device 108a, which is also disposed inside the cavity portion 104a. The slider 106a has a communication hole 107a. The communication hole 107a is formed as a labyrinth and is constituted as follows. That is, when the slider 106a is moved rightward by a biasing force of the spring device 108a, the communication hole 107a allows the air communication hole 105a to be communicated with the atmosphere (communication position, see FIGS. 4 and 5A). On the other hand, when the slider 106a is pressed by the switching member 153a of the ink supply mechanism 151a due to the movement of the carriage 11 and is moved leftward against the biasing force of the spring device 108a, the communication hole 107a disallows the air communication hole 105a to be communicated with the atmosphere (non-communication position, see FIG. 5B).

The tank body 102a is provided with an ink supply opening 109a for receiving an ink supply from the ink supply nozzle 152a. The ink supply opening 109a is disposed to face the ink supply nozzle 152a of the ink supply mechanism 151a. The ink supply opening 109a can be attached to/detached from the ink supply nozzle 152a by the movement of the carriage 11. The ink supply opening 109a includes an internal valve (not shown) that can seal the ink supply opening 109a when the ink supply nozzle 152a is separated from the ink supply opening 109a.

[Description of Ink Supply Mechanism 151a]

The structure of the ink supply mechanism 151a provided in the printer 3 is described hereinafter.

As shown in FIG. 4, the ink supply mechanism 151a includes an ink supply nozzle 152a for supplying ink to the tank body 102a of the sub-tank 101a, and the switching member 153a for pressing the slider 106a of the exhaust portion 103a provided in the recording head 10. The ink supply nozzle 152a is arranged to face the ink supply opening 109a of the sub-tank 101a. The ink supply nozzle 152a can be attached to/detached from the ink supply opening 109a of the sub-tank 101a by the movement of the carriage 11. Two packings 154a, such as O-rings for sealing, are attached to the ink supply nozzle 152a. The switching member 153a is arranged to face the slider 106a of the exhaust portion 103a provided in the recording head 10. The switching member 153a can be attached to/detached from the slider 106a by the movement of the carriage 11.

The positional relationship between the slider 106a and the ink supply opening 109a provided in the recording head 10, and the switching member 153a and the ink supply nozzle 152a provided in the ink supply mechanism 151a, is set as follows. That is, the recording head 10 and the ink supply mechanism 151a can be brought into the following states (1-1) to (1-3) by moving the carriage 11 (recording head 10) in the horizontal direction through the driving force of the carriage motor 30.

(1-1) The slider 106a of the recording head 10 and the switching member 153a of the ink supply mechanism 151a are separated. The tank body 102a of the sub-tank 101a is communicated with the atmosphere via the air communication hole 105a and the communication hole 107a. The ink supply nozzle 152a of the ink supply mechanism 151a is not connected to the ink supply opening 109a of the recording head 10 (see FIG. 4).

(1-2) The slider 106a of the recording head 10 is pressed by the switching member 153a of the ink supply mechanism 151a and moved leftward. The tank body 102a of the sub-tank 101a is still communicated with the atmosphere via the air communication hole 105a and the communication hole 107a. The ink supply nozzle 152a of the ink supply mechanism 151a is connected to the ink supply opening 109a of the recording head 10 so that ink can be supplied from the ink cartridge 21a to the sub-tank 101a (see FIG. 5A).

(1-3) The slider 106a of the recording head 10 is pressed by the switching member 153a of the ink supply mechanism 151a and moved further leftward. The tank body 102a of the sub-tank 101a is no longer communicated with the atmosphere. The ink supply nozzle 152a of the ink supply mechanism 151a is connected to the ink supply opening 109a of the recording head 10 so that ink can be supplied from the ink cartridge 21a to the sub-tank 101a (see FIG. 5B).

[Description of Control Processor 70 (Control System of Printer 3)]

The structure of the control processor 70 is described hereinafter by way of FIG. 3. FIG. 3 is a block diagram showing a schematic structure of the control processor 70.

Referring to FIG. 3, the control processor 70 includes a microcomputer provided with CPU 71, ROM 72, RAM 73, and EEPROM 74. The resist sensor 69, the media sensor 68, the sheet delivery encoder 50, the operation panel 6, and the carriage feed encoder 39 are electrically connected to the control processor 70.

Also, driving circuits 76a to 76c for respectively driving the feed motor 65, the sheet delivery motor 40, and the carriage motor 30, a recording head driving circuit 76d for driving the recording head 10, and a driving circuit 76e for driving a pressurized pump 111 are electrically connected to the control processor 70. A personal computer 77 (PC 77) can be also connected to the control processor 70

When the control processor 70 (more particularly, CPU 71) receives instructions for recording onto a sheet P from the PC 77 or from other functioning blocks such as for copying, faxing, etc. of the multifunctional apparatus 1, a sheet end detection process that detects an end position of the sheet P is initially performed. Then, based on results of the detection, a recording process that records an image onto the sheet P is performed. If recording to the next page is necessary, the sheet end detection process and the recording process are performed again with respect to another sheet P for the next page. If recording to the next page is not necessary, the process is ended. In this manner, image forming onto the sheet P is performed. The sheet end detection process and the recording process herein follow the well-known techniques in the art. Therefore, detailed explanation thereof is omitted.

The control processor 70 can supply four colors of ink from the ink cartridges 21a to 21d to the sub-tanks 101a to 101d of the recording head 10 by driving the pressurized pump 111 via the driving circuit 76e.

The control processor 70 moves the carriage 11 (recording head 10) in the horizontal direction by controlling the carriage motor 30. The control processor 70 can bring the recording head 10 and the ink supply mechanisms 151a to 151d into the aforementioned states (1-1) to (1-3) by changing the relative position between the recording head 10 and the ink supply mechanisms 151a to 151d.

[Description of Operation of Carriage Mechanism]

The operation of the carriage mechanism performed by the control processor 70 is explained by way of FIGS. 4 and 5A to 5C.

During standby, the carriage motor 30 is driven to move the carriage 11 rightward. The ink supply nozzle 152a is connected to the ink supply opening 109a. Also, the switching member 153a moves the slider 106a leftward against the biasing force of the spring device 108a. However, the air connection hole 105a is still communicated with the atmosphere (ink supply position, see FIG. 5A, in FIGS. 5A and 5C, the end position of the recording head 10 in the ink supply position is indicated by a reference symbol “B”). In this case, ink can be supplied from the ink cartridge 21a to the sub-tank 101a of the recording head 10 by driving the pressurized pump 111 (standby mode and ink supply mode, see FIGS. 5A and 5C).

Now, in order to perform image recording onto the sheet, the carriage motor 30 is driven to move the carriage 11 leftward. The ink supply nozzle 152a is separated from the ink supply opening 109a. The switching member 153a is separated from the slider 106a (recording position, see FIG. 4, in FIGS. 4 and 5A to 5C, the end position of the recording head 10 in the recording position is indicated by a reference symbol “A”). In this case, the ink supply opening 109a is sealed with the internal valve, while the air communication hole 105a continues to be communicated with the atmosphere (recording (printing) mode, see FIGS. 4 and 5C). The carriage 11 is moved further leftward by driving the carriage motor 30, and the aforementioned sheet end detection process and recording process are executed.

On the other hand, in order to recover ink discharge performance of the recording head 10, the carriage motor 30 is driven to move the carriage 11 further rightward. The ink supply nozzle 152a is connected to the ink supply opening 109a. Also, the switching member 153a moves the slider 106a leftward against the biasing force of the spring device 108a, such that the communication hole 107a of the slider 106a and the air communication hole 105a are no longer communicated (discharge performance recovery position, see FIG. 5B, in FIGS. 5A to 5C, the end portion of the recording head 10 at the discharge performance recovery position is indicated by a reference symbol “C”). Even after the ink supply nozzle 152a is connected to the ink supply opening 109a, the carriage 11 can be moved further rightward due to the elasticity of the packings 154a. In this case, ink can be supplied from the ink cartridge 21a to the sub-tank 101a of the recording head 10 by driving the pressurized pump 111 (during discharge performance recovery (positive pressure purge), see FIGS. 5B and 5C). The ink discharge performance by the ink nozzle group 10a of the recording head 10 can be recovered by discharging ink from the ink nozzle group 10a.

[Effects]

According to the first embodiment, the following effects can be achieved. In the multifunctional apparatus 1, one pressurized portion such as the pressurized pump 111 is used. Also, the recording head 10 includes the slider 106a that opens/closes the air communication hole 105a of the sub-tank 101a. Furthermore, the switching member 153a is provided that switches the communication state between the air communication hole 105a and the atmosphere by moving the slider 106a. The switching member 153a is integrally formed with the ink supply mechanism 151a. Accordingly, depending on the relative position between the sub-tank 101a of the recording head 10 and the ink supply mechanisms 151a, the operation mode of the printer 3 can be easily switched to at least the following three modes: (a) “recording mode” that enables image recording onto a sheet; (b) “ink supply mode (standby mode)” in which the sub-tank 101a is supplied with ink; and (c) “discharge performance recovery mode” in which the discharge performance of the ink nozzle group 10a of the recording head 10 is recovered. Therefore, the multifunctional apparatus 1 can be composed of a fewer number of parts, and easily controlled as compared to the conventional ink jet recording apparatus.

According to the multifunctional apparatus 1 of the first embodiment, the control processor 70 controls the carriage motor 30 to move the carriage 11 (recording head 10) in the horizontal direction, so that the relative position between the sub-tank 101a of the recording head 10 and the ink supply mechanism 151a can be modified. Therefore, while the load to the carriage motor 30 is increased, the multifunctional apparatus 1 can be composed of a fewer number of parts since no additional driving mechanism is necessary for moving the ink supply mechanism 151a.

According to the multifunctional apparatus 1 of the first embodiment, the ink supply opening 109a has an internal valve that can seal the ink supply opening 109a when the ink supply nozzle 152a is separated from the ink supply opening 109a. Therefore, even if the multifunctional apparatus 1 is accidentally placed upside down, leakage of ink can be prevented as much as possible.

### Second Embodiment

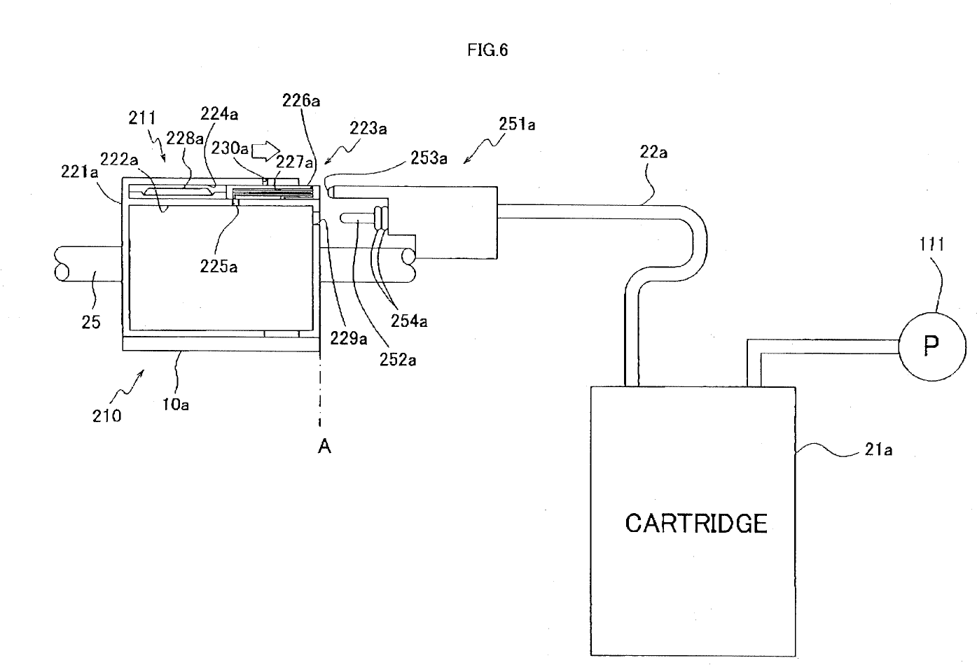

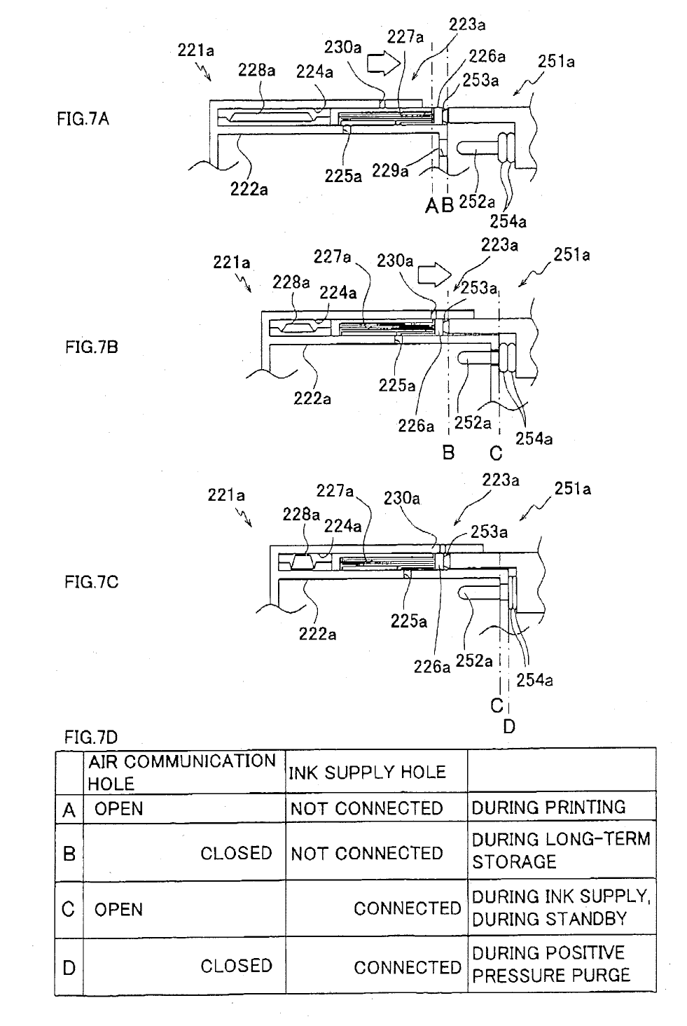

In the first embodiment, the control processor 70 controls the carriage motor 30 to move the carriage 11 (recording head 10) in the horizontal direction. Depending on the relative position between the sub-tank 101a of the recording head 10 and the supply mechanism 151a, the control processor 70 easily switches the operation mode of the printer 3 to the three modes: (a) “recording mode”; (b) “ink supply mode (standby mode)”; and (c) “discharge performance recovery mode”. In addition to the aforementioned three operation modes, the control processor 70 in the second embodiment shown in FIGS. 6 and 7A to 7C is designed to easily switch the operation mode of the printer 3 to a fourth operation mode: (d) “long-term storage mode” in which the ink inside the sub-tank 221a of the recording head 210 is to be stored for a long period of time.

Hereinafter, the structure of the multifunctional apparatus 1 according to the second embodiment is described by way of FIGS. 6 and 7A to 7C. Many of the components are common in both the first and second embodiments. Therefore, the same reference numbers are given to identical components, and descriptions thereof are not repeated.

[Description of Recording Head 210]

As shown in FIG. 6, a recording head 210 has internal sub-tanks 221a to 221d (only 221a is shown in this figure), each of which stores one of four colors of ink. The sub-tanks 221a to 221d are the same in structure. Therefore, in the following description, only the structure of the sub-tank 221a for one specific color of ink will be explained in detail. Descriptions of the sub-tanks 221b to 221d for the other colors of ink are arbitrarily omitted. The same applies to ink supply mechanisms 251a to 251d. The sub-tank 221a is provided with a tank body 222a for storing ink, and an exhaust portion 223a for discharging the air inside the tank body 222a to the outside. The exhaust portion 223a includes a cavity portion 224a, an air communication hole 225a, a slider 226a, and a spring device 228a. The cavity portion 224a is formed on top of the recording head 210 and opens rightward. The air communication hole 225a communicates the tank body 222a with the atmosphere via the cavity portion 224a. At least a part of the slider 226a is disposed inside the cavity portion 224a. The slider 226a opens/closes the air communication hole 225a.

The cavity portion 224a is arranged to face a switching member 253a of the later-explained ink supply mechanism 251a. The cavity portion 224a communicates with the tank body 222a via the air communication hole 225a. Accordingly, the tank body 222a is communicated with the atmosphere via the cavity portion 224a and the air communication hole 225a. The cavity portion 224a is also provided with a cavity communication hole 230a that communicates the cavity portion 224a with the atmosphere.

The slider 226a can be moved in the horizontal direction inside the cavity portion 224a. The slider 226a is pressed rightward by the spring device 228a, which is also disposed inside the cavity portion 224a. The slider 226a has a communication hole 227a The communication hole 227a is formed as a labyrinth and is constituted as follows. That is, when the slider 226a is moved rightward by a biasing force of the spring device 228a, the communication hole 227a allows the air communication hole 225a to be communicated with the atmosphere (communication position, see FIG. 6). When the slider 226a is pressed with the switching member 253a of the ink supply mechanism 251a by the movement of a carriage 211 and moved leftward against the biasing force of the spring device 228a, the communication hole 227a disallows the air communication hole 225a to be communicated with the atmosphere (non-communication position, see FIG. 7A). When the slider 226a is pressed with the switching member 253a of the ink supply mechanism 251a by the movement of the carriage 211 and is moved further leftward against the biasing force of the spring device 228a, the communication hole 227a allows the air communication hole 225a to be communicated with the atmosphere via the cavity communication hole 230a of the cavity portion 224a (communication position, see FIG. 7B). When the slider 226a is pressed with the switching member 253a of the ink supply mechanism 251a by the movement of the carriage 211 and is moved much further leftward against the biasing force of the spring device 228a, the communication hole 227a again disallows the air communication hole 225a to be communicated with the atmosphere (non-communication position, see FIG. 7C).

The tank body 222a is provided with an ink supply opening 229a for receiving ink supply from an ink supply nozzle 252a. The ink supply opening 229a is disposed to face the ink supply nozzle 252a of the ink supply mechanism 251a. The ink supply opening 229a can be attached to/detached from the ink supply nozzle 252a by the movement of the carriage 211. The ink supply opening 229a includes an internal valve (not shown) that can seal the ink supply opening 229a when the ink supply nozzle 252a is separated from the ink supply opening 229a.

[Description of Ink Supply Mechanism 251a]

As shown in FIG. 6, the ink supply mechanism 251a includes an ink supply nozzle 252a for supplying ink to the tank body 222a of the sub-tank 221a, and the switching member 253a for pressing the slider 226a of the exhaust portion 223a provided in the recording head 210. The ink supply nozzle 252a is arranged to face the ink supply opening 229a of the sub-tank 221a. The ink supply nozzle 252a can be attached to/detached from the ink supply opening 229a of the sub-tank 221a by the movement of the carriage 211. Two packings 254a, such as O-rings for sealing, are attached to the ink supply nozzle 252a. The switching member 253a is arranged to face the slider 226a of the exhaust portion 223a provided in the recording head 210. The switching member 253a can be attached to/detached from the slider 226a by the movement of the carriage 211.

The positional relationship between the slider 226a and the ink supply opening 229a provided in the recording head 210, and the switching member 253a and the ink supply nozzle 252a provided in the ink supply mechanism 251a, is set as follows. That is, the recording head 210 and the ink supply mechanism 251a can be brought into the following states (2-1) to (2-4) by moving the carriage 211 (recording head 210) in the horizontal direction through the driving force of the carriage motor 30.

(2-1) The slider 226a of the recording head 210 and the switching member 253a of the ink supply mechanism 251a are separated. The tank body 222a of the sub-tank 221a is communicated with the atmosphere via the air communication hole 225a and the communication hole 227a. The ink supply nozzle 252a of the ink supply mechanism 251a is not connected to the ink supply opening 229a of the recording head 210 (see FIG. 6).

(2-2) The slider 226a of the recording head 210 is pressed by the switching member 253a of the ink supply mechanism 251a and moved leftward, such that the tank body 222a of the sub-tank 221a is no longer communicated with the atmosphere. The ink supply nozzle 252a of the ink supply mechanism 251a is not connected to the ink supply opening 229a of the recording head 210 (see FIG. 7A).

(2-3) The slider 226a of the recording head 210 is pressed by the switching member 253a of the ink supply mechanism 251a to move further leftward, such that the tank body 222a of the sub-tank 221a is again communicated with the atmosphere via the air communication hole 225a and the cavity communication hole 230a. The ink supply nozzle 252a of the ink supply mechanism 251a is connected to the ink supply opening 229a of the recording head 210 so that ink can be supplied from the ink cartridge 21a (see FIG. 6) to the sub-tank 221a (see FIG. 7B).

(2-4) The slider 226a of the recording head 210 is pressed by the switching member 253a of the ink supply mechanism 251a and moved much further leftward. The tank body 222a of the sub-tank 221a is no longer communicated with the atmosphere. The ink supply nozzle 252a of the ink supply mechanism 251a is connected to the ink supply opening 229a of the recording head 210 so that ink can be supplied from the ink cartridge 21a (see FIG. 6) to the sub-tank 221a (see FIG. 7C).

[Description of Control Processor 70]

The control processor 70 moves the carriage 211 (recording head 210) in the horizontal direction by controlling the carriage motor 30. The control processor 70 can bring the recording head 210 and the ink supply mechanisms 251a to 251d into the aforementioned states (2-1) to (2-4) by changing the relative position between the recording head 210 and the ink supply mechanisms 251a to 251d.

[Description of Operation of Carriage Mechanism]

In the second embodiment as described above, the control processor 70 operates carriage mechanism as follows.

During standby, the carriage motor 30 is driven to move the carriage 211 rightward. The ink supply nozzle 252a is connected to the ink supply opening 229a. While the switching member 253a moves the slider 226a rightward against the biasing force of the spring device 228a, the air connection hole 225a is communicated with the atmosphere via the communication hole 227a and the cavity communication hole 230a (ink supply position, see FIG. 7B, in FIGS. 7A to 7D, the end position of the recording head 210 in the ink supply position is indicated by the reference symbol “C”). In this case, ink can be supplied from the ink cartridge 21a (see FIG. 6) to the sub-tank 221a of the recording head 210 by driving the pressurized pump 111 (see FIG. 6) (standby mode and ink supply mode, see FIGS. 7B and 7D).

Here, in order to store the ink inside of the sub-tank 221a for a long period of time, the carriage motor 30 is driven to move the carriage 211 leftward. The ink supply nozzle 252a is separated from the ink supply opening 229a. While the switching member 253a still keeps the slider 226a leftward against the biasing force of the spring device 228, the communication hole 227a of the slider 226a is no longer communicated with the air communication hole 225a (long-term storage position, see FIGS. 7A and 7D, long-term storage mode, in FIGS. 7A to 7D, the end position of the recording head 210 in the long-term storage position is indicated by the reference symbol “B”).

In order to perform image recording onto a sheet, the carriage motor 30 is driven to move the carriage 211 further leftward. The ink supply nozzle 252a is separated from the ink supply opening 229a. The switching member 253a is also separated from the slider 226a (recording position, see FIG. 6, in FIGS. 6 and 7A to 7C, the end position of the recording head 210 in the recording position is indicated by the reference symbol “A”). In this case, the ink supply opening 229a is sealed with the internal valve, while the air communication hole 225a continues to be communicated with the atmosphere (recording (printing) mode, see FIGS. 6 and 7B). The carriage 211 is moved further leftward by driving the carriage motor 30, and the aforementioned sheet end detection process and recording process are executed.

On the other hand, in order to recover a discharge performance of ink of the recording head 210, the carriage motor 30 is driven to move the carriage 211 further rightward. The ink supply nozzle 252a is connected to the ink supply opening 229a. The switching member 253a moves the slider 226a leftward against the biasing force of the spring device 228a, such that the communication hole 227a of the slider 226a and the air communication hole 225a are not communicated (discharge performance recovery position, see FIG. 7C, in FIGS. 7A to 7D, the end position of the recording head 210 at the discharge performance recovery position is indicated by a reference symbol “D”). Even after the ink supply nozzle 252a is connected to the ink supply opening 229a, the carriage 211 can be moved further rightward due to the elasticity of the packings 254a. In this case, ink can be supplied from the ink cartridge 21a to the sub-tank 221a of the recording head 210 by driving the pressurized pump 111 (during discharge performance recovery (positive pressure purge), see FIGS. 7C and 7D). The ink discharge performance by the ink nozzle group 10a of the recording head 210 can be recovered by discharging ink from the ink nozzle group 10a.

[Effects]

According to the second embodiment, the sub-tank 221a can be sealed by closing the air communication hole 225a with the slider 226a. Therefore, in addition to achieving the effects in the first embodiment, the second embodiment can cope with a long-term storage, such as shipping, of the multifunctional apparatus 1.

### Third Embodiment

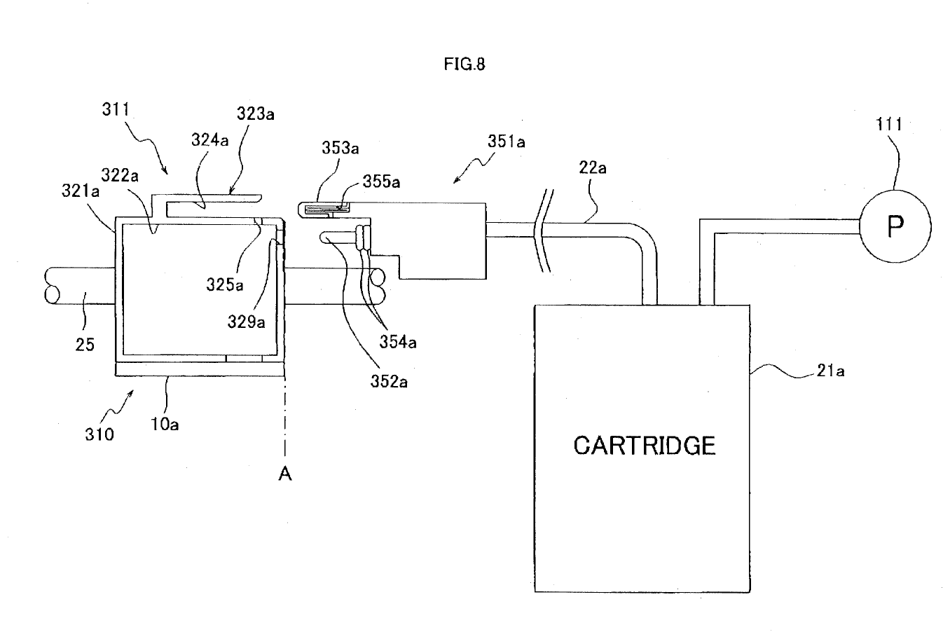

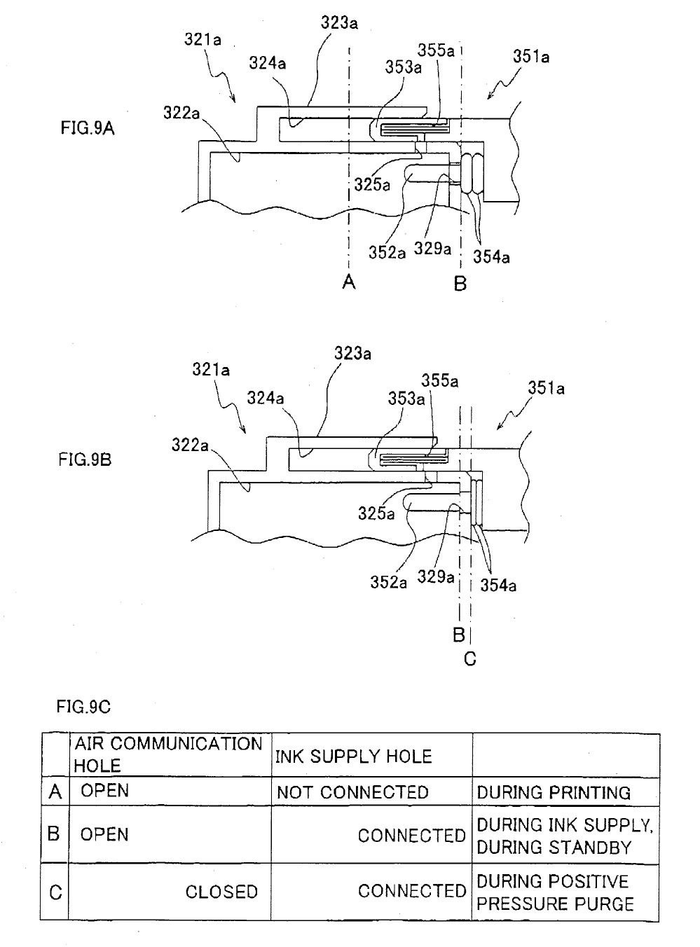

In the recording head 10 of the first embodiment, the slider 106a that opens/closes the air communication hole 105a of the sub-tank 101a is provided in a manner to be movable in the horizontal direction. Furthermore, the switching member 153a, which switches the communication state of the air communication hole 105a with the atmosphere by moving the slider 106a, is integrally formed with the ink supply mechanism 151a. In the third embodiment shown in FIGS. 8 and 9A to 9C, a switching member communication hole 355a, for switching the open/close state of the air communication hole 325a of a sub-tank 321a, is provided in a switching member 353a of an ink supply mechanism 351a.

Hereinafter, the structure of the multifunctional apparatus 1 according to the third embodiment is described by way of FIGS. 8 and 9A to 9C. Many of the components are common in both of the first and third embodiments. Therefore, the same reference numbers are given to identical components, and descriptions thereof are not repeated.

[Description of Recording Head 310]

As shown in FIG. 8, a recording head 310 has internal sub-tanks 321a to 321d, each of which stores one of four colors of ink. The sub-tanks 321a to 321d are the same in structure. Therefore, in the following description, only the structure of the sub-tank 321a, for one specific color of ink will be explained in detail. Descriptions of the sub-tanks 321b to 321d for the other colors of ink are arbitrarily omitted. The same applies to ink supply mechanisms 351a to 351d. The sub-tank 321a is provided with a tank body 322a for storing ink, and an exhaust portion 323a for discharging the air inside of the tank body 322a to the outside. The exhaust portion 323a includes a cavity portion 324a, and an air communication hole 325a. The cavity portion 324a is formed on the top of the recording head 310 and opens rightward. The air communication hole 325a communicates the tank body 322a with the atmosphere via the cavity portion 324a.

The cavity portion 324a is arranged to face a switching member 353a of the later-explained ink supply mechanism 351a. The cavity portion 324a communicates with the tank body 322a via the air communication hole 325a. Accordingly, the tank body 322a is communicated with the atmosphere via the cavity portion 324a and the air communication hole 325a.

The tank body 322a is provided with an ink supply opening 329a for receiving ink supply from an ink supply nozzle 352a. The ink supply opening 329a is disposed to face the ink supply nozzle 352a of the ink supply mechanism 351a. The ink supply opening 329a can be attached to/detached from the ink supply nozzle 352a by the movement of the carriage 311. The ink supply opening 329a includes an internal valve (not shown) that can seal the ink supply opening 329a when the ink supply nozzle 352a is separated from the ink supply opening 329a.

[Description of Ink Supply Mechanism 351a]

As shown in FIG. 8, the ink supply mechanism 351a includes an ink supply nozzle 352a for supplying ink to the tank body 322a of the sub-tank 321a, and the switching member 353a for switching the communication state of the air communication hole 325a of the exhaust portion 323a provided in the recording head 310. The ink supply nozzle 352a is arranged to face the ink supply opening 329a of the sub-tank 321a. The ink supply nozzle 352a can be attached to/detached from the ink supply opening 329a of the sub-tank 321a by the movement of the carriage 311. Two packings 354a, such as O-rings for sealing, are attached to the ink supply nozzle 252a. The switching member 353a is arranged to face the cavity 324a of the exhaust portion 323a provided in the recording head 310. The switching member 353a can be moved into the cavity portion 324a by the movement of the carriage 311. The switching member 353a has the switching member communication hole 355a. The switching member communication hole 355a is formed as a labyrinth and is constituted as follows. That is, when the switching member 353a is separated from the cavity portion 324a by the movement of the carriage 311, the switching member communication hole 355a allows the air communication hole 325a to be communicated with the atmosphere (communication position, see FIG. 8). When the switching member 353a is inserted into the cavity portion 324a by the movement of the carriage 311, the switching member communication hole 355a allows the air communication hole 325a to be communicated with the atmosphere (communication position, see FIG. 9A). When the switching member 353a is moved further into the cavity portion 324a by the movement of the carriage 311, switching member communication hole 355a disallows the air communication hole 325a to be communicated with the atmosphere (non-communication position, see FIG. 9B).

The positional relationship between the air communication hole 325a and the ink supply opening 329a provided in the recording head 310, and the switching member 353a and the ink supply nozzle 352a provided in the ink supply mechanism 351a, is set as follows. That is, the recording head 310 and the ink supply mechanism 351a can be brought into the following states (3-1) to (3-3) by moving the carriage 311 (recording head 310) in the horizontal direction through the driving force of the carriage motor 30.

(3-1) The switching member 353a is separated from the cavity portion 324a. The air communication hole 325a is communicated with the atmosphere. The ink supply nozzle 352a of the ink supply mechanism 351a is not connected to the ink supply opening 329a of the recording head 310 (communication position, see FIG. 8).

(3-2) The switching member 353a is inserted into the cavity portion 324a, such that the air communication hole 325a is communicated with the atmosphere via the switching member communication hole 355a of the switching member 353a. The ink supply nozzle 352a of the ink supply mechanism 351a is connected to the ink supply opening 329a of the recording head 310 so that ink can be supplied from the ink cartridge 21a to the sub-tank 321a (communication position, see FIG. 9A).

(3-3) The switching member 353a is inserted further into the cavity portion 324a. The air communication hole 325a is no longer communicated with the atmosphere. The ink supply nozzle 352a of the ink supply mechanism 351a is connected to the ink supply opening 329a of the recording head 310 so that ink can be supplied from the ink cartridge 21a to the sub-tank 321a (non-communication position, see FIG. 91B).

[Description of Control Processor 701

The control processor 70 moves the carriage 311 (recording head 310) in the horizontal direction by controlling the carriage motor 30. The control processor 70 can bring the recording head 310 and the ink supply mechanisms 351a to 351d into the aforementioned states (3-1) to (3-3) by changing the relative position between the recording head 310 and the ink supply mechanisms 351a to 351d.

[Description of Operation of Carriage Mechanism]

In the third embodiment as described above, the control processor 70 operates the carriage mechanism as follows.

During standby, the carriage motor 30 is driven to move the carriage 311 rightward. The ink supply nozzle 352a is connected to the ink supply opening 329a. The switching member 353a is inserted into the cavity portion 324a, so that the air connection hole 325a is communicated with the atmosphere via the switching member communication hole 355a (ink supply position, see FIG. 9A, in FIGS. 9A to 9C, the end position of the recording head 310 in the ink supply position is indicated by the reference symbol “B”). In this case, ink can be supplied from the ink cartridge 21a to the sub-tank 321a of the recording head 310 by driving the pressurized pump 111 (see FIG. 8) (standby mode and ink supply mode, see FIGS. 9A and 9C).

Now, in order to perform image recording onto a sheet, the carriage motor 30 is driven to move the carriage 311 leftward. The ink supply nozzle 352a is separated from the ink supply opening 329a, and the switching member 353a is also separated from the cavity portion 324a (recording position, see FIG. 8, in FIGS. 8 and 9A to 9C, the end position of the recording head 310 in the recording position is indicated by the reference symbol “A”). In this case, the ink supply opening 329a is sealed with the internal valve) while the air communication hole 325a continues to be communicated with the atmosphere (recording (printing) mode, see FIGS. 8 and 9C). The carriage 311 is moved further leftward by driving the carriage motor 30. The aforementioned sheet end detection process and recording process are executed.

On the other hand, in order to recover the ink discharge performance of the recording head 310, the carriage motor 30 is driven to move the carriage 311 further rightward, such that the ink supply nozzle 352a is connected to the ink supply opening 329a. The switching member 353a is inserted further into the cavity portion 324a, such that the air communication hole 325a and the atmosphere are no longer communicated (discharge performance recovery position, see FIG. 9B, in FIGS. 9A to 9C, the end position of the recording head 310 at the discharge performance recovery position is indicated by the reference symbol “C”). Even after the ink supply nozzle 352a is connected to the ink supply opening 329a, the carriage 311 can be moved further rightward due to the elasticity of packings 354a. In this case, ink can be supplied from the ink cartridge 21a to the sub-tank 321a of the recording head 310 by driving the pressurized pump 111 (see FIG. 8) (during discharge performance recovery (positive pressure purge), see FIGS. 9B and 9C). The ink discharge performance by the ink nozzle group 10a of the recording head 310 can be recovered by discharging ink from the ink nozzle group 10a.

[Effects]

According to the third embodiment, the same effects as those described in the first embodiment can be achieved.

### Fourth Embodiment

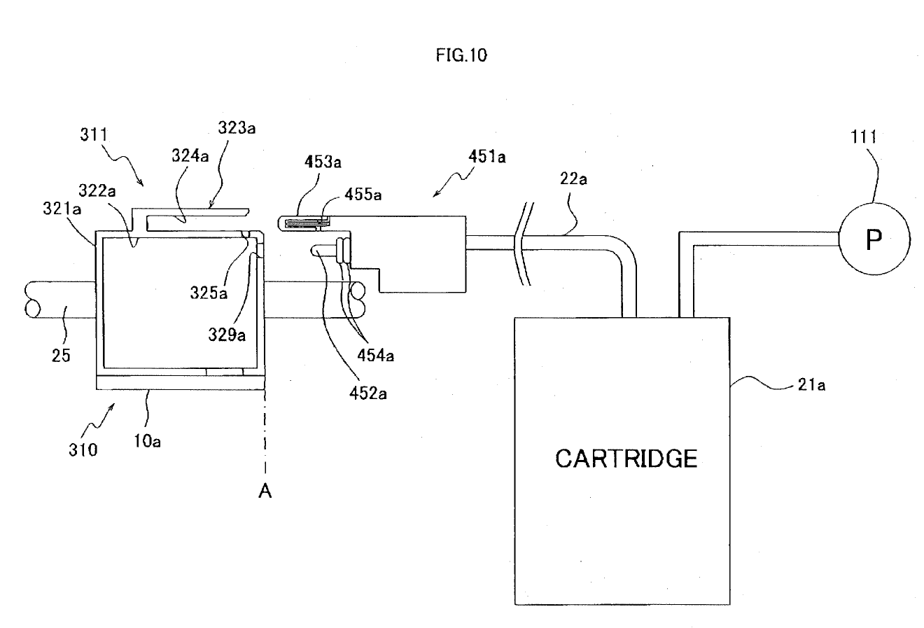

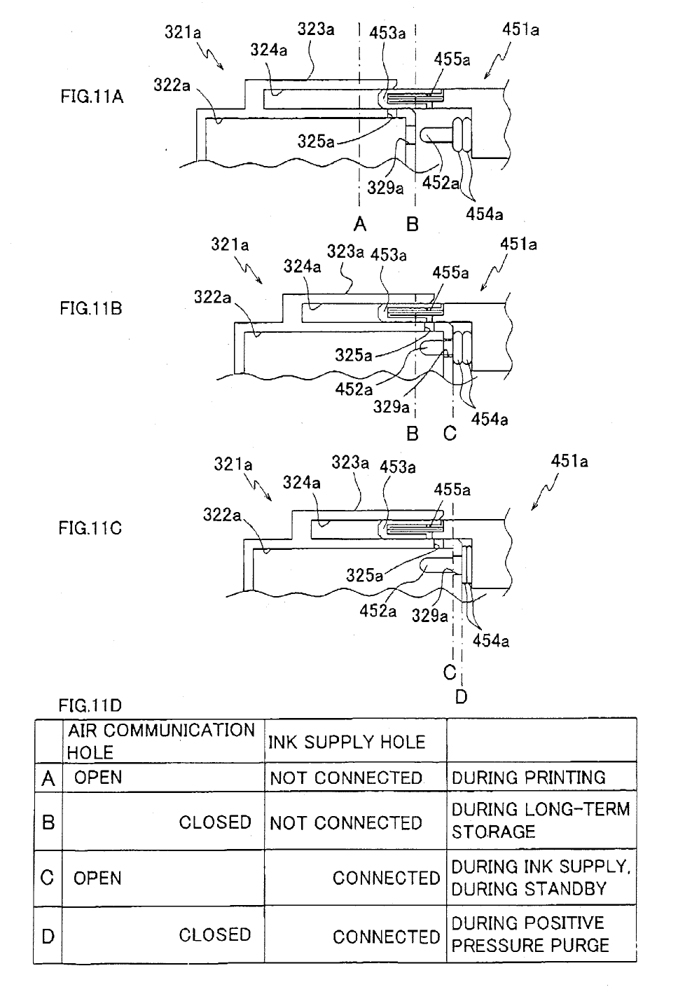

In the third embodiment, the switching member communication hole 355a for switching the open/close state of the air communication hole 325a of the sub-tank 321a is provided in the switching member 353a of the ink supply mechanism 351a. Also, the control processor 70 controls the carriage motor 30 to move the carriage 311 (recording head 310) in the horizontal direction, and, depending on the relative position between the sub-tank 321a of the recording head 310 and the supply mechanism 351a, the control processor 70 easily switches the operation mode of the printer 3 to the three modes: (a) “recording mode”; (b) “ink supply mode (standby mode)”; and (c) “discharge performance recovery mode”. In addition to the aforementioned three operation modes, the control processor 70 in the fourth embodiment shown in FIGS. 10 and 11A to 11D is designed to easily switch the operation mode of the printer 3 to a fourth operation mode: (d) “long-term storage mode” in which the ink inside the sub-tank 321a of the recording head 310 is to be stored for a long period of time.

Hereinafter, the structure of the multifunctional apparatus 1 according to the fourth embodiment is described by way of FIGS. 10 and 11A to 11D. Many of the components are common in both the third and fourth embodiments. Therefore, the same reference numbers are given to identical components, and descriptions thereof are not repeated. Also, ink supply mechanisms 451a to 451d (only ink supply mechanism 451a is shown in FIG. 10) are the same in structure. Accordingly, in the following description, only the structure of the ink supply mechanism 451a for one specific color of ink will be given, and descriptions on the ink supply mechanisms 451b to 451d for the other colors of ink are arbitrarily omitted.

Description of Ink Supply Mechanism 451a]

As shown in FIG. 10, the ink supply mechanism 451a includes an ink supply nozzle 452a for supplying ink to the tank body 322a of the sub-tank 321a, and the switching member 453a for switching the communication state of the air communication hole 325a of the exhaust portion 323a is provided in the recording head 310. The ink supply nozzle 452a is arranged to face the ink supply opening 329a of the sub-tank 321a. The ink supply nozzle 452a can be attached to/detached from the ink supply opening 329a of the sub-tank 321a by the movement of the carriage 311. Two packings 454a, such as O-rings for sealing, are attached to the ink supply nozzle 452a. The switching member 453a is arranged to face the cavity portion 324a of the exhaust portion 323a provided in the recording head 310. The switching member 453a can be moved into the cavity portion 324a by the movement of the carriage 311. The switching member 453a has a switching member communication hole 455a. The switching member communication hole 455a is formed as a labyrinth and is constituted as follows. That is, when the switching member 453a is separated from the cavity portion 324a by the movement of the carriage 311, the switching member communication hole 455a allows the air communication hole 325a to be communicated with the atmosphere (communication position, see FIG. 10). When the switching member 453a is inserted into the cavity portion 324a by the movement of the carriage 311, the switching member communication hole 455a and the air communication hole 325a are no longer communicated. Thus, the air communication hole 325a is not communicated with the atmosphere (non-communication position, see FIG. 11A). When the switching member 453a is moved further into the cavity portion 324a by the movement of the carriage 311, the switching member communication hole 455a and the air communication hole 325a are communicated again. Thus, the air communication hole 325a is communicated with the atmosphere (communication position, see FIG. 11B). When the switching member 453a is moved much further into the cavity portion 324a by the movement of the carriage 311, the switching member communication hole 455a and the air communication hole 325a are no longer communicated. Thus, the air communication hole 325a is not communicated with the atmosphere (non-communication position, see FIG. 11C).

The positional relationship between the air communication hole 325a provided in the recording head 310 and the ink supply opening 329a, and the switching member 453a provided in the ink supply mechanism 451a and the ink supply nozzle 452a, is set as follows. That is, the recording head 310 and the ink supply mechanism 451a can be brought into the following states (4-1) to (4-4) by moving the carriage 311 (recording head 310) in the horizontal direction through the driving force of the carriage motor 30.

(4-1) The switching member 453a is separated from the cavity portion 324a. The air communication hole 325a is communicated with the atmosphere. The ink supply nozzle 452a of the ink supply mechanism 451a is not connected to the ink supply opening 329a of the recording head 310 (communication position, see FIG. 10).

(4-2) The switching member 453a is inserted into the cavity portion 324a, such that the switching member communication hole 455a and the air communication hole 325a are not communicated. The air communication hole 325a is no longer communicated with the atmosphere. The ink supply nozzle 452a of the ink supply mechanism 451a is not connected to the ink supply opening 329a of the recording head 310 so that ink cannot be supplied from the ink cartridge 21a to the sub-tank 321a (non-communication position, see FIG. 11A).

(4-3) The switching member 453a is inserted further into the cavity portion 324a, such that the air communication hole 325a is communicated with the atmosphere. The ink supply nozzle 452a of the ink supply mechanism 451a is connected to the ink supply opening 329a of the recording head 310 so that ink can be supplied from the ink cartridge 21a to the sub-tank 321a (communication position, see FIG. 11B)

(4-4) The switching member 453a is inserted much further into the cavity portion 324a. The switching member communication hole 455a and the air communication hole 325a are no longer communicated. The air communication hole 325a is no longer communicated with the atmosphere. The ink supply nozzle 452a of the ink supply mechanism 451a is connected to the ink supply opening 329a of the recording head 310 so that ink can be supplied from the ink cartridge 21a to the sub-tank 321a (non-communication position, see FIG. 11C).

[Description of Control Processor 70]

The control processor 70 moves the carriage 311 (recording head 310) in the horizontal direction by controlling the carriage motor 30. The control processor 70 can bring the recording head 310 and the ink supply mechanisms 451a to 451d into the aforementioned states (4-1) to (4-4) by changing the relative position between the recording head 310 and the ink supply mechanisms 451a to 451d.

[Description of Operation of Carriage Mechanism]

In the fourth embodiment as described above, the control processor 70 operates the carriage mechanism as follows.

During standby, the carriage motor 30 is driven to move the carriage 311 rightward. The ink supply nozzle 452a is connected to the ink supply opening 329a. The switching member 453a is inserted into the cavity portion 324a, such that the air connection hole 325a is communicated with the atmosphere via the switching member communication hole 455a (ink supply position, see FIG. 11B, in FIGS. 11A to 11D, the end position of the recording head 310 in the ink supply position is indicated by the reference symbol “C”). In this case, ink can be supplied from the ink cartridge 21a to the sub-tank 321a of the recording head 310 by driving the pressurized pump 111 (see FIG. 10) (standby mode and ink supply mode, see FIGS. 11B and 11D).

Here, in order to store the ink inside the sub-tank 321a for a long period of time, the carriage motor 30 is driven to move the carriage 311 leftward, such that the ink supply nozzle 452a is separated from the ink supply opening 329a, and the switching member communication hole 455a and the air communication hole 325a are no longer communicated. The air communication hole 325a is no longer communicated with the atmosphere (long-term storage position, see FIGS. 11A and 11D, long-term storage mode, in FIGS. 11A to 11D, the end position of the recording head 310 in the long-term storage position is indicated by the reference symbol “B”).

In order to perform image recording onto the sheet, the carriage motor 30 is driven to move the carriage 311 further leftward. The ink supply nozzle 452a is separated from the ink supply opening 329a. The switching member 453a is also separated from the cavity portion 324a (recording position, see FIG. 10, in FIGS. 10 and 11A to 11C, the end position of the recording head 310 in the recording position is indicated by the reference symbol “A”). In this case, the ink supply opening 329a is scaled with the internal valve, while the air communication hole 325a is communicated with the atmosphere (recording (printing) mode, see FIGS. 10 and 11D). The carriage 311 is moved further leftward by driving the carriage motor 30, and the aforementioned sheet end detection process and recording process are executed.

On the other hand, in order to recover a discharge performance of ink of the recording head 310, the carriage motor 30 is driven to move the carriage 311 further rightward. The ink supply nozzle 452a is connected to the ink supply opening 329a. The switching member 453a is inserted further into the cavity portion 324a, such that the switching member communication hole 455a and the air communication hole 325a are not communicated. The air communication hole 325a is no longer communicated with the atmosphere (discharge performance recovery position, see FIG. 11C, in FIGS. 11A to 11D, the end position of the recording head 310 at the discharge performance recovery position is indicated by the reference symbol “D”). Even after the ink supply nozzle 452a is connected to the ink supply opening 329a, the carriage 311 can be moved further rightward due to the elasticity of the packings 454a. In this case, ink can be supplied from the ink cartridge 21a to the sub-tank 321a of the recording head 310 by driving the pressurized pump 111 (see FIG. 10) (during discharge performance recovery (positive pressure purge), see FIGS. 11C and 11D). The ink discharge performance by the ink nozzle group 10a of the recording head 310 can be recovered by discharging ink from the ink nozzle group 10a.

[Effects]

According to the fourth embodiment, the sub-tank 321a can be sealed by closing the air communication hole 325a with the switching member 453a. Therefore, in addition to achieving the effects in the third embodiment, the fourth embodiment can cope with a long-term storage, such as shipping, of the multifunctional apparatus 1.

### Fifth Embodiment

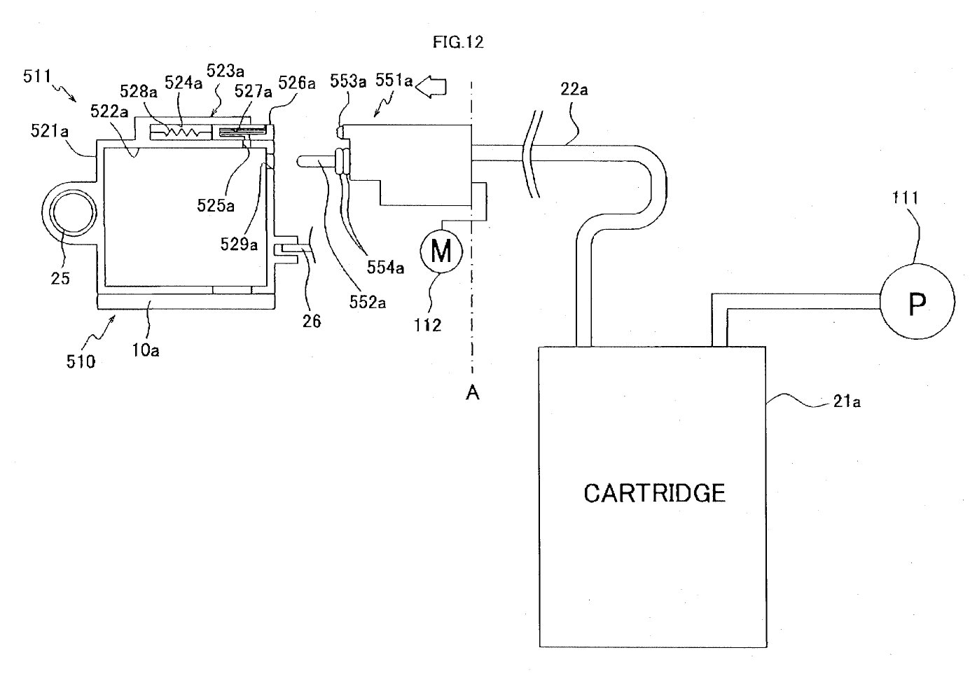

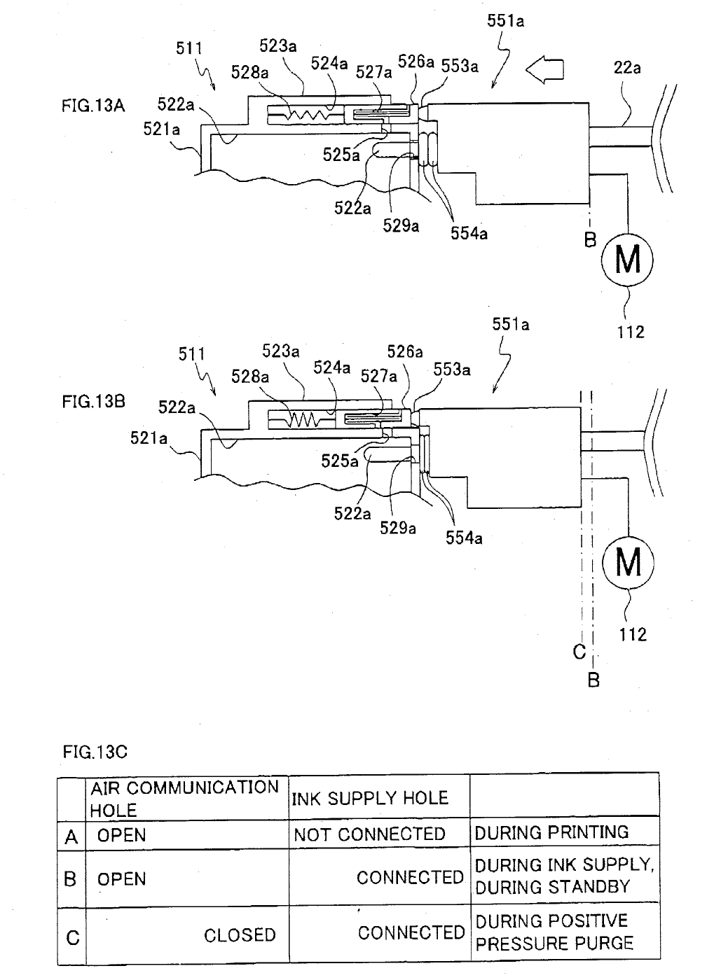

The control processor 70 of the first embodiment is designed to move the carriage 11 (recording head 10) by controlling the carriage motor 30, and change the relative position between the sub-tank 101a provided in the recording head 10 and the ink supply mechanism 151a. In the fifth embodiment shown in FIGS. 12 and 13A to 13C, a driving mechanism for moving an ink supply mechanism 551a is separately provided. The control processor 70 controls an ink supply mechanism driving motor 112 to move the ink supply mechanism 551a to and fro, and to change the relative position between a sub-tank 521a provided in a recording head 510 and the ink supply mechanism 551a.

Hereinafter, the structure of the multifunctional apparatus according to the fifth embodiment is described by way of FIGS. 12 and 13A to 13C. Many of the components are common in both of the first and fifth embodiments. Therefore, the same reference numbers are given to identical components, and descriptions thereof are not repeated.

[Description of Recording Head 510]

As shown in FIG. 12, a recording head 510 has internal sub-tanks 521a to 521d (only internal sub-tank 521a is shown in FIG. 12), each of which stores one of four colors of ink. The sub-tanks 521a to 521d are the same in structure. Therefore) in the following description, only the structure of the sub-tank 521a for one specific color of ink will be explained in detail. Descriptions of the sub-tanks 521b to 521d for the other colors of ink are arbitrarily omitted. The same applies to ink supply mechanisms 551a to 551d. The sub-tank 521a is provided with a tank body 522a for storing ink, and an exhaust portion 523a for discharging the air inside the tank body 522a to the outside. The exhaust portion 523a includes a cavity portion 524a, an air communication hole 525a, a slider 526a, and a spring device 528a. The cavity portion 524a is formed on top of the recording head 510 and opens frontward. The air communication hole 525a communicates the tank body 522a with the atmosphere via the cavity portion 524a. At least a part of the slider 526a is disposed inside of the cavity portion 524a. The slider 526a opens/closes the air communication hole 525a.

The cavity portion 524a is arranged to face a switching member 553a of the later-explained ink supply mechanism 551a. The cavity portion 524a communicates with the tank body 522a via the air communication hole 525a. Accordingly, the tank body 522a is communicated with the atmosphere via the cavity portion 524a and the air communication hole 525a.

The slider 526a can be moved to the front and rear inside the cavity portion 524a. The slider 526a is pressed frontward by the spring device 528a, which is also disposed inside the cavity portion 524a. The slider 526a has a communication hole 527a. The communication hole 527a is formed as a labyrinth and is constituted as follows. That is, when the slider 526a is moved frontward by a biasing force of the spring device 528a, the communication hole 527a allows the air communication hole 525a to be communicated with the atmosphere (communication position, see FIG. 12). When the slider 526a is pressed with the switching member 553a by the movement of the ink supply mechanism 551a and is moved rearward against the biasing force of the spring device 528a, the communication hole 527a disallows the air communication hole 525a to be communicated with the atmosphere (non-communication position, see FIG. 13B)

The tank body 522a is provided with an ink supply opening 529a for receiving an ink supply from an ink supply nozzle 552a. The ink supply opening 529a is disposed to face the ink supply nozzle 552a of the ink supply mechanism 551a. The ink supply opening 529a can be attached to/detached from the ink supply nozzle 552a by the movement of the ink supply mechanism 551a. The ink supply opening 529a includes an internal valve (not shown) that can seal the ink supply opening 529a when the ink supply nozzle 552a is separated from the ink supply opening 529a.

[Description of Ink Supply Mechanism 551a]

As shown in FIG. 12, the ink supply mechanism 551a includes an ink supply nozzle 552a for supplying ink to the tank body 522a of the sub-tank 521a, and the switching member 553a for pressing the slider 526a of the exhaust portion 523a provided in the recording head 510. The ink supply mechanism 551a is disposed ahead of the carriage 511 (recording head 510) when the carriage 511 is located above the wiper or caps of the maintenance mechanism (given position). Also, the ink supply mechanism 551a can be moved to the front and rear by the driving force of the ink supply mechanism driving motor 112. The ink supply nozzle 552a is arranged to face the ink supply opening 529a of the sub-tank 521a. The ink supply nozzle 552a can be attached to/detached from the ink supply opening 529a of the sub-tank 521a by the movement of the ink supply mechanism 551a. Two packings 554a, such as O-rings for sealing, are attached to the ink supply nozzle 552a. The switching member 553a is arranged to face the slider 526a of the exhaust portion 523a provided in the recording head 510. The switching member 553a can be attached to/detached from the slider 526a by the movement of the ink supply mechanism 551a.

The positional relationship between the air communication hole 525a and the ink supply opening 529a provided in the recording head 510, and the switching member 553a and the ink supply nozzle 552a provided in the ink supply mechanism 551a, is set as follows. That is, the recording head 510 and the ink supply mechanism 551a can be brought into the following states (5-1) to (5-3) by moving the ink supply mechanism 551a to the front and rear by the driving force of the ink supply mechanism driving motor 112.

(5-1) The slider 526a of the recording head 510 and the ink supply mechanism 551a are separated. The tank body 522a of the sub-tank 521a is communicated with the atmosphere via the air communication hole 525a and the communication hole 527a. The ink supply nozzle 552a of the ink supply mechanism 551a is not connected to the ink supply opening 529a of the recording head 510 (communication position, see FIG. 12).

(5-2) The slider 526a of the recording head 510 is pressed with the switching member 553a of the ink supply mechanism 551a and moved rearward. The tank body 522a of the sub-tank 521a is still communicated with the atmosphere via the air communication hole 525a and the communication hole 527a. The ink supply nozzle 552a of the ink supply mechanism 551a is connected to the ink supply opening 529a of the recording head 510 so that ink can be supplied from the ink cartridge 21a to the sub-tank 521a (communication position, see FIG. 13A).

(5-3) The slider 526a of the recording head 510 is pressed with the switching member 553a of the ink supply mechanism 551a and moved further rearward. The tank body 522a of the sub-tank 521a is no longer communicated with the atmosphere. The ink supply nozzle 552a of the ink supply mechanism 551a is connected to the ink supply opening 529a of the recording head 510 so that ink can be supplied from the ink cartridge 21a to the sub-tank 521a (non-communication position, see FIG. 13B).

[Description of Control Processor 70]

The control processor 70 moves the ink supply mechanisms 551a to 551d to the front and rear by controlling the ink supply mechanism driving motor 112 via a driving circuit (not shown). The control processor 70 can bring the recording head 510 and the ink supply mechanisms 551a to 551d into the aforementioned states (5-1) to (5-3) by changing the relative position between the recording head 510 and the ink supply mechanisms 551a to 551d.

[Description of Operation of Ink Supply Mechanism 551a]

In the fifth embodiment as described above, the control processor 70 operates the ink supply mechanism 551a as follows.

During standby when the carriage 511 (recording head 510) is located above the wiper and caps of the maintenance mechanism (given position), the ink supply mechanism driving motor 112 is driven to move the ink supply mechanism 551a rearward. The ink supply nozzle 552a is connected to the ink supply opening 529a. While the switching member 553a moves the slider 526a rearward against a biasing force of the spring device 528a, the air connection hole 525a is communicated with the atmosphere (ink supply position, see FIG. 13A, in FIGS. 13A to 13C, the end position of the ink supply mechanism 551a in the ink supply position is indicated by the reference symbol “B”). In this case, ink can be supplied from the ink cartridge 21a to the sub-tank 521a of the recording head 510 by driving the pressurized pump 111 (see FIG. 12) (standby mode and ink supply mode, see FIGS. 13A and 13C)

Now, in order to perform image recording onto a sheet, the ink supply mechanism motor 112 is driven to move the ink supply mechanism 551a frontward. The ink supply nozzle 552a is separated from the ink supply opening 529a. The switching member 553a is also separated from the slider 526a (recording position, see FIG. 12, in FIG. 12, the end position of the ink supply mechanism 551a in the recording position is indicated by the reference symbol “A”). In this case, the ink supply opening 529a is sealed with the internal valve, while the air communication hole 525a continues to be communicated with the atmosphere (recording (printing) mode, see FIGS. 12 and 13C). The carriage 511 is moved leftward by driving the carriage motor 30, and the aforementioned sheet end detection process and recording process are executed.

On the other hand, in order to recover an ink discharge performance of the recording head 510, the ink supply mechanism driving motor 112, when the carriage 511 (recording head 510) is above the wiper and the caps of the maintenance mechanism (given position), is driven to move the ink supply mechanism 551a further rearward. The ink supply nozzle 552a is connected to the ink supply opening 529a. The switching member 553a moves the slider 526a rearward against the biasing force of the spring device 528a such that the communication hole 527a of the slider 526a and the air communication hole 225a are not communicated (discharge performance recovery position, see FIG. 13B, in FIGS. 13A to 13C, the end position of the ink supply mechanism 551a at the discharge performance recovery position is indicated by the reference symbol “C”). Even after the ink supply nozzle 552a is connected to the ink supply opening 529a, the ink supply mechanism 551a can be moved further rearward due to the elasticity of packings 554a. In this cases ink can be supplied from the ink cartridge 21a to the sub-tank 521a of the recording head 510 by driving the pressurized pump 111 (see FIG. 12) (during discharge performance recovery (positive pressure purge), see FIGS. 13B and 13C). The ink discharge performance by the ink nozzle group 10a of the recording head 510 can be recovered by discharging ink from the ink nozzle group 10a.

[Effects]

In the fifth embodiment, the load to the carriage motor 30 is reduced since a supplementary driving mechanism for moving the ink supply mechanism 551a is provided. Accordingly, in addition to the effects described in the first embodiment, miniaturization and a longer operating life of the carriage motor 30 can be achieved.

### Sixth Embodiment

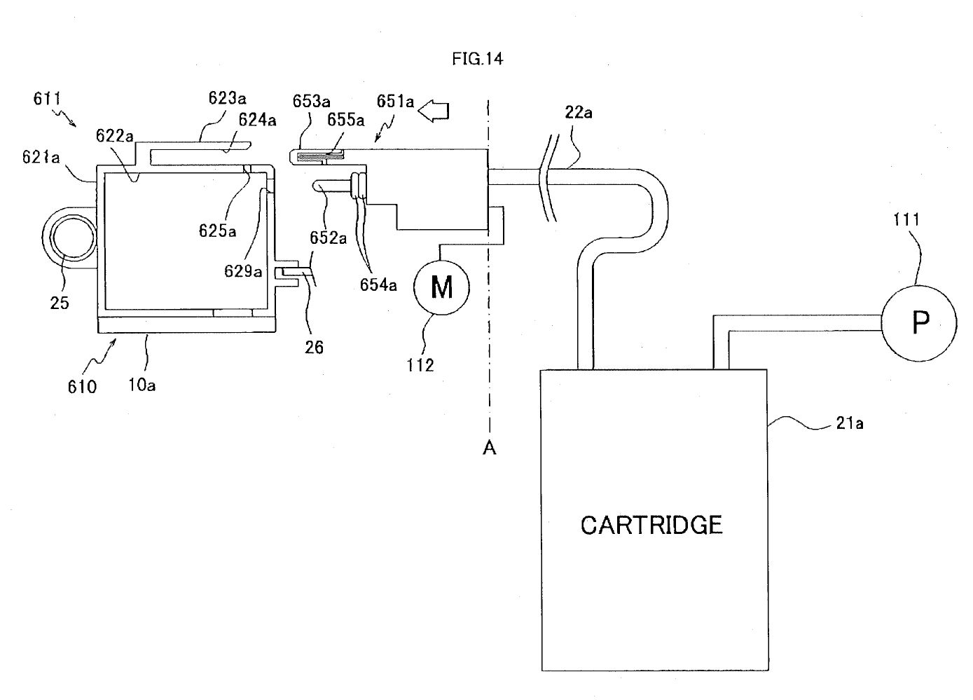

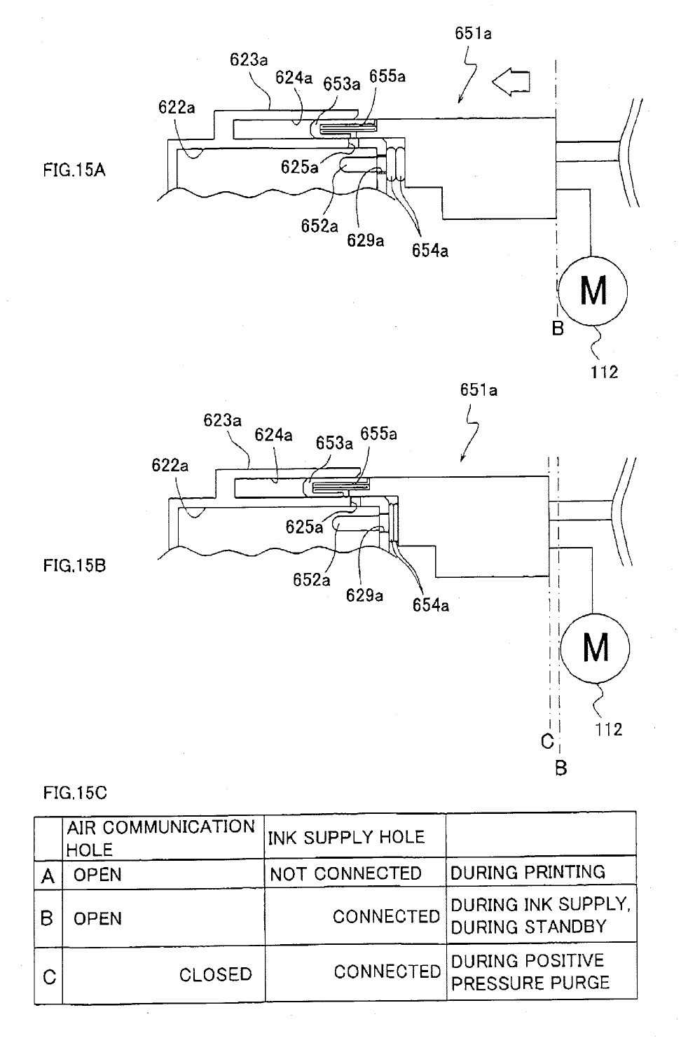

In the recording head 510 of the fifth embodiment, the slider 526a that opens/closes the air communication hole 525a of the sub-tank 521a is provided in a manner to be movable to the front and rear. Furthermore, the switching member 553a that switches the communication state of the air communication hole 525a with the atmosphere by moving the slider 526a is integrally formed with the ink supply mechanism 551a. Moreover, a driving mechanism for moving the ink supply mechanism 551a is additionally provided. Thus, the control processor 70 moves the ink supply mechanism 551a to the front and rear by controlling the ink supply mechanism driving motor 112, and changes the relative position between the sub-tank 521a of the recording head 510 and the ink supply mechanism 551a. In the sixth embodiment shown in FIGS. 14 and 15A to 15C, a switching member communication hole 655a for switching the open/close state of the air communication hole 625a of a sub-tank 621a is provided in a switching member 653a of an ink supply mechanism 651a.

Hereinafter, the structure of the multifunctional apparatus according to the sixth embodiment is described by way of FIGS. 14 and 15A to 15C. Many of the components are common in both of the fifth and sixth embodiments. Therefore, the same reference numbers are given to identical components, and descriptions thereof are not repeated.

[Description of Recording Head 610]

As shown in FIG. 14, a recording head 610 has internal sub-tanks 621a to 621d (only internal sub-tank 621a is shown in FIG. 14), each of which stores one of four colors of ink. The sub-tanks 621a to 621d are the same in structure. Therefore, in the following description, only the structure of the sub-tank 621a for one specific color of ink will be explained in detail. Descriptions of the sub-tanks 621b to 621d for the other colors of ink are arbitrarily omitted. The same applies to ink supply mechanisms 651a to 651d. The sub-tank 621a is provided with a tank body 622a for storing ink, and an exhaust portion 623a for discharging the air inside the tank body 622a to the outside. The exhaust portion 623a includes a cavity portion 624a, and an air communication hole 625a. The cavity portion 624a is formed on the top of the recording head 610 and opens frontward. The air communication hole 625a communicates the tank body 622a with the atmosphere via the cavity portion 624a.

The cavity portion 624a is arranged to face a switching member 653a of the later-explained ink supply mechanism 651a. The cavity portion 624a is communicated with the tank body 622a via the air communication hole 625a. Accordingly, the tank body 622a is communicated with the atmosphere via the cavity portion 624a and the air communication hole 625a.

The tank body 622a is provided with an ink supply opening 629a for receiving an ink supply from an ink supply nozzle 652a. The ink supply opening 629a is disposed to face the ink supply nozzle 652a of the ink supply mechanism 651a. The ink supply opening 629a can be attached to/detached from the ink supply nozzle 652a by the movement of the ink supply mechanism 651a. The ink supply opening 629a includes an internal valve (not shown) that can seal the ink supply opening 629a when the ink supply nozzle 652a is separated from the ink supply opening 629a.

[Description of Ink Supply Mechanism 651a]

As shown in FIG. 14, the ink supply mechanism 651a includes an ink supply nozzle 652a for supplying ink to the tank body 622a of the sub-tank 621a, and the switching member 653a for switching the communication state of the air communication hole 625a of the exhaust portion 623a is provided in the recording head 610. The ink supply mechanism 651a is disposed ahead of the carriage 611 (recording head 610) when the carriage 611 is located above the wiper or caps of the maintenance mechanism (given position). Also, the ink supply mechanism 651a can be moved to the front and rear by the driving force of the ink supply mechanism driving motor 112, which is controlled by the control processor 70. The ink supply nozzle 652a is arranged to face the ink supply opening 629a of the sub-tank 621a. The ink supply nozzle 652a can be attached to/detached from the ink supply opening 629a of the sub-tank 621a by the movement of the ink supply mechanism 651a. Two packings 654a, such as O-rings for sealing, are attached to the ink supply nozzle 652a. The switching member 653a is arranged to face the cavity portion 624a of the exhaust portion 623a provided in the recording head 610. The switching member 653a can be moved into the cavity portion 624a by the movement of the carriage 611. The switching member 653a has a switching member communication hole 655a. The switching member communication hole 655a is formed as a labyrinth and is constituted as follows. That is, when the switching member 653a is separated from the cavity portion 624a by the movement of the ink supply mechanism 651a, the switching member communication hole 655a allows the air communication hole 625a to be communicated with the atmosphere (communication position, see FIG. 14). When the switching member 653a is inserted into the cavity portion 624a by the movement of the ink supply mechanism 651a, the switching member communication hole 655a allows the air communication hole 625a to be communicated with the atmosphere (communication position, see FIG. 15A). When the switching member 653a is inserted further into the cavity portion 624a by the movement of the carriage 611, the switching member communication hole 655a disallows the air communication hole to be communicated with the atmosphere (non-communication position, see FIG. 15B).

The positional relationship between the air communication hole 625a and the ink supply opening 629a provided in the recording head 610, and the switching member 653a and the ink supply nozzle 652a provided in the ink supply mechanism 651a, is set as follows. That is, the recording head 610 and the ink supply mechanism 651a can be brought into the following states (6-1) to (6-3) by moving the ink supply mechanism 651a to the front and rear by the driving force of the ink supply mechanism driving motor 112.

(6-1) The switching member 653a is separated from the cavity portion 624a. The air communication hole 625a and the atmosphere are communicated. The ink supply nozzle 652a of the ink supply mechanism 651a is not connected to the ink supply opening 629a of the recording head 610 (communication position, see FIG. 14).

(6-2) The switching member 653a is inserted into the cavity portion 624a. The air communication hole 625a and the atmosphere are communicated via the switching member communication hole 655a of the switching member 653a. The ink supply nozzle 652a of the ink supply mechanism 651a is connected to the ink supply opening 629a of the recording head 610 so that ink can be supplied from the ink cartridge 21a to the sub-tank 621a (communication position, see FIG. 15A).

(6-3) The switching member 653a is inserted further into the cavity portion 624a. The air communication hole 625a is no longer communicated with the atmosphere. The ink supply nozzle 652a of the ink supply mechanism 651a is connected to the ink supply opening 629a of the recording head 610 so that ink can be supplied from the ink cartridge 21a to the sub-tank 621a (non-communication position, see FIG. 15B).

[Description of Control Processor 70]

The control processor 70 moves the ink supply mechanisms 651a to 651d to the front and rear by controlling the ink supply mechanism driving motor 112 via a driving circuit (not shown). The control processor 70 can bring the recording head 610 and the ink supply mechanisms 651a to 651d into the aforementioned states (6-1) to (6-3) by changing the relative position between the recording head 610 and the ink supply mechanisms 651a to 651d.

[Description of Operation of Ink Supply Mechanism 651a]

In the sixth embodiment as described above, the control processor 70 operates the ink supply mechanism 651a as follows.

During standby when the carriage 611 (recording head 610) is located above the wiper and caps of the maintenance mechanism (given position), the ink supply mechanism driving motor 112 is driven to move the ink supply mechanism 651a rearward. The ink supply nozzle 652a is connected to the ink supply opening 629a. The switching member 653a is inserted into the cavity portion 624a, such that the air connection hole 625a is communicated with the atmosphere via the switching member communication hole 655a of the switching member 653a (ink supply position, see FIG. 15A, in FIGS. 15A to 15C, the end position of the ink supply mechanism 651a in the ink supply position is indicated by the reference symbol “B”). In this case, ink can be supplied from the ink cartridge 21a to the sub-tank 621a of the recording head 610 by driving the pressurized pump 111 (see FIG. 14) (standby mode and ink supply mode, see FIGS. 15A and 15C).

Now, in order to perform image recording onto a sheet, the ink supply mechanism motor 112 is driven to move the ink supply mechanism 651a frontward. The ink supply nozzle 652a is separated from the ink supply opening 629a. The switching member 653a is also separated from the cavity portion 624a (recording position, see FIG. 14, in FIG. 14, the end position of the ink supply mechanism 651a in the recording position is indicated by the reference symbol “A”). In this case, the ink supply opening 629a is sealed with an internal valve, while the air communication hole 625a continues to be communicated with the atmosphere (recording (printing) mode, see FIGS. 14 and 15C). The carriage 611 is moved leftward by driving the carriage motor 30, and the aforementioned sheet end detection process and recording process are executed.

On the other hand, in order to recover the ink discharge performance of the recording head 610, the ink supply mechanism driving motor 112, when the carriage 611 (recording head 610) is above the wiper and the caps of the maintenance mechanism (given position), is driven to move the ink supply mechanism 651a further rearward. The ink supply nozzle 652a is connected to the ink supply opening 629a. The switching member 653a is inserted into further into the cavity portion 624a, such that the air communication hole 625a is no longer communicated with the atmosphere (discharge performance recovery position, see FIG. 15B) in FIGS. 15A to 15C, the end position of the ink supply mechanism 651a at the discharge performance recovery position is indicated by the reference symbol “C”). Even after the ink supply nozzle 652a is connected to the ink supply opening 629a, the ink supply mechanism 651a can be moved further rearward due to the elasticity of packings 654a. In this case, ink can be supplied from the ink cartridge 21a to the sub-tank 621a of the recording head 610 by driving the pressurized pump 111 (see FIG. 14) (during discharge performance recovery (positive pressure purge), see FIGS. 15B and 15C). The ink discharge performance by the ink nozzle group 10a of the recording head 610 can be recovered by discharging ink from the ink nozzle group 10a.

[Effects]

According to the sixth embodiment, the same effects as those described in the fifth embodiment can be achieved.

### Seventh Embodiment

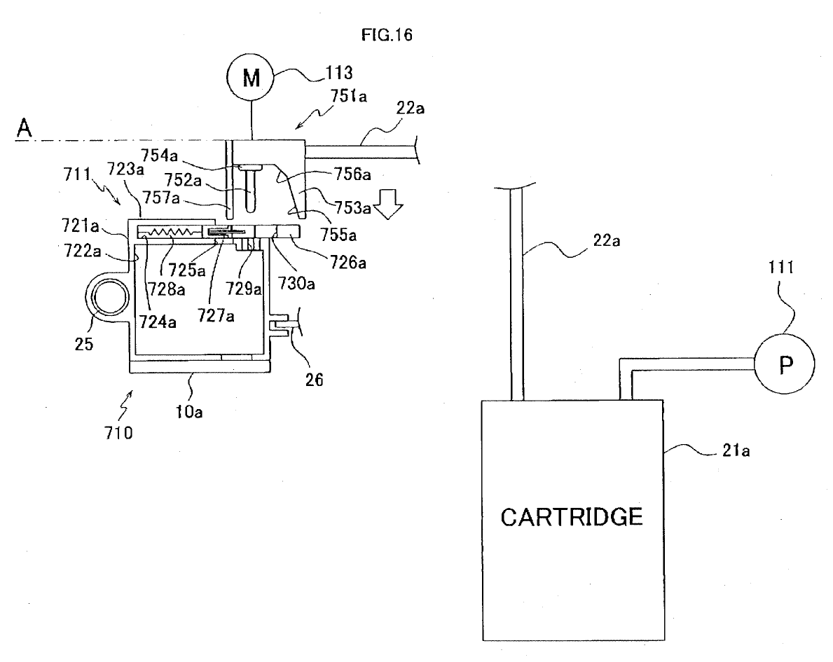

In the sixth embodiment, the control processor 70 moves the ink supply mechanism 651a, disposed ahead of the carriage 611 (recording head 610) when the carriage 611 is located above the wiper and caps of the maintenance mechanism (given position), to the front and rear by controlling the ink supply mechanism driving motor 112, and changes the relative position between the sub-tank 621a of the recording head 610 and the ink supply mechanism 651a. In the seventh embodiment shown in FIGS. 16, 17A, 17B, 18A and 18B, the control processor 70 is designed to move a ink supply mechanism 751a, disposed above a carriage 711 (recording head 710) when the carriage 711 is located above the wiper and caps of the maintenance mechanism (given position), in a vertical direction by controlling an ink supply mechanism driving motor 113, and changes the relative position between a sub-tank 721a of the recording head 710 and an ink supply mechanism 751a.

Hereinafter, the structure of the multifunctional apparatus according to the seventh embodiment is described by way of FIGS. 16, 17A, 17B, 18A and 18B. Many of the components are common in both of the sixth and seventh embodiments. Therefore, the same reference numbers are given to identical components, and descriptions thereof are not repeated.

[Description of Recording Head 710]

As shown in FIG. 16, a recording head 710 has internal sub-tanks 721a to 721d (only internal sub-tank 721a is shown in FIG. 16), each of which stores one of four colors of ink. The sub-tanks 721a to 721d are the same in structure. Therefore, in the following description, only the structure of the sub-tank 721a for one specific color of ink will be explained in detail. Descriptions of the sub-tanks 721b to 721d for the other colors of ink are arbitrarily omitted. The same applies to ink supply mechanisms 751a to 751d. The sub-tank 721a is provided with a tank body 722a for storing ink, and an exhaust portion 723a for discharging the air inside the tank body 722a to the outside. The exhaust portion 723a includes a cavity portion 724a, an air communication hole 725a, a slider 726a, and a spring device 728a. The cavity portion 724a is formed on top of the recording head 710 and opens frontward. The air communication hole 725a is a long hole that communicates the tank body 722a with the atmosphere via the cavity portion 724a. At least a part of the slider 726a is disposed inside the cavity portion 724a. The slider 726a opens/closes the air communication hole 725a.

The tank body 722a is provided with an ink supply opening 729a for receiving ink supply from an ink supply nozzle 752a. The ink supply opening 729a is disposed to face the ink supply nozzle 752a of the ink supply mechanism 751a. The ink supply opening 729a can be attached to/detached from the ink supply nozzle 752a by the movement of the ink supply mechanism 751a. The ink supply opening 729a includes an internal valve (not shown) that can seal the ink supply opening 729a when the ink supply nozzle 752a is separated from the ink supply opening 729a.

The cavity portion 724a is arranged to face a switching member 753a of the later-explained ink supply mechanism 751a. The cavity portion 724a is communicated with the tank body 722a via the air communication hole 725a. Accordingly, the tank body 722a is communicated with the atmosphere via the cavity portion 724a and the air communication hole 725a.

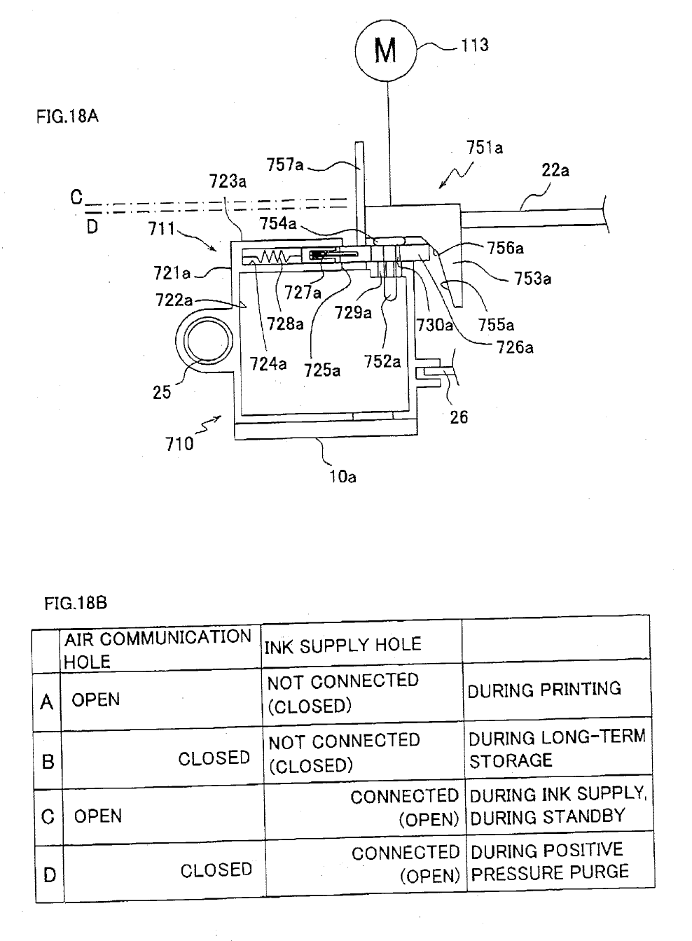

The slider 726a can be moved to the front and rear inside the cavity portion 724a. The slider 726a is pressed frontward by the spring device 728a that is also disposed inside the cavity portion 724a. The slider 726a has a communication hole 727a. The communication hole 727a is formed as a labyrinth and is constituted as follows. That is, when the slider 726a is moved frontward by a biasing force of the spring device 728a, the communication hole 727a allows the air communication hole 725a to be communicated with the atmosphere (communication position, see FIG. 16). When the slider 726a is pressed with the switching member 753a by the movement of the ink supply mechanism 751a and moved rearward against the biasing force of the spring device 728a, the communication hole 727a disallows the air communication hole 725a to be communicated with the atmosphere (non-communication position, see FIG. 18A).

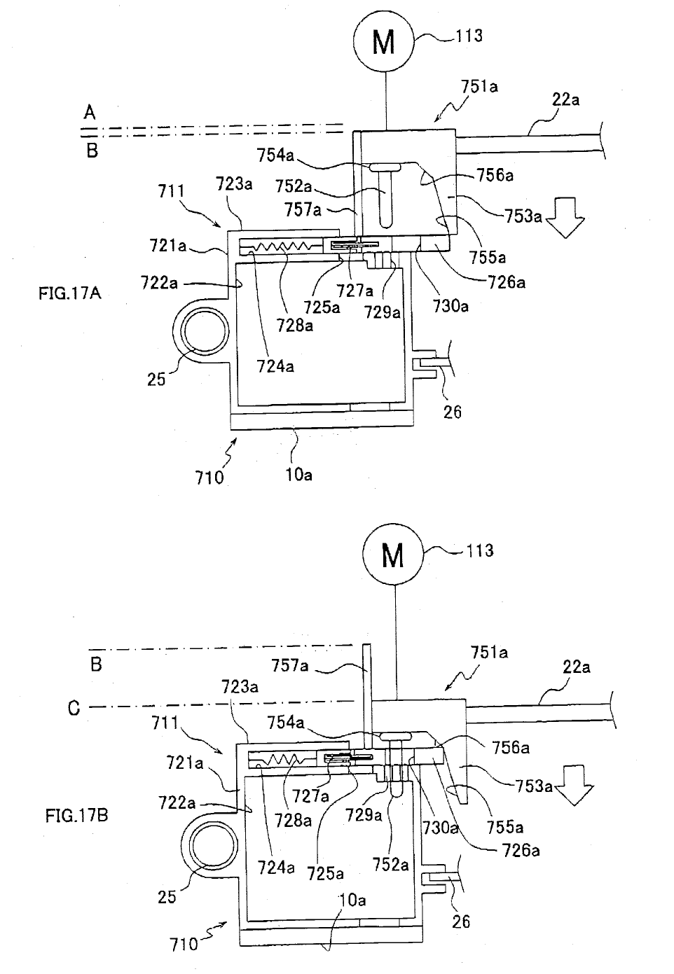

Also, the slider 726a has a long through hole 730a at a front portion. The through hole 730a is constituted as follows. That is, when the slider 726a is moved frontward by the biasing force of the spring device 728a, the through hole 730a is not communicated with the ink supply opening 729a (see FIG. 16). When the slider 726a is pressed by the switching member 753a through the movement of the later-explained ink supply mechanism 751a and moved rearward against the biasing force of the spring device 728a, the through hole 730a is communicated with the ink supply opening 729a (see FIGS. 17B and 18A).

[Description of Ink Supply Mechanism 751a]

As shown in FIG. 16, the ink supply mechanism 751a includes an ink supply nozzle 752a for supplying ink to the tank body 722a of the sub-tank 721a, and a switching member 753a for pressing the slider 726a of the exhaust portion 723a provided in the recording head 710. The ink supply mechanism 751a is disposed above the carriage 711 (recording head 710) when the carriage 711 is located above the wiper or caps of the maintenance mechanism (given position). Also, the ink supply mechanism 751a can be moved in the vertical direction by the driving force of the ink supply mechanism driving motor 113, which is controlled by the control processor 70. The ink supply nozzle 752a is arranged to face the ink supply opening 729a of the sub-tank 721a. The ink supply nozzle 752a can be attached to/detached from the ink supply opening 729a of the sub-tank 721a by the movement of the ink supply mechanism 751a. Two packings 754a, such as O-rings for sealing, are attached to the ink supply nozzle 752a. The switching member 753a is arranged to face the slider 726a of the exhaust portion 723a provided in the recording head 710. The switching member 753a can be attached to/detached from the slider 726a by the movement of the ink supply mechanism 751a. The switching member 753a is provided with two cam faces 755a, 756a having different slant angles with respect to the moving direction of the slider 726a. These cam faces are formed into a shape such that the distance moved by the slider 726a when the switching member 753a is moved in the vertical direction together with the movement of the ink supply mechanism 751a and abutted on the slider 726a, differs depending upon the moved position of the ink supply mechanism 751a. In the present embodiment, the switching member 753a is provided with two cam faces 755a, 756a. However, the switching member 753a may be provided with only one cam face or three or more cam faces.

The ink supply mechanism 751a also includes a closing member 757a for closing the communication hole 727a of the slider 726a for a long-term storage. The closing member 757a is provided with the ink supply mechanism 751a in a manner movable in the vertical direction. The closing member 757a is biased to look downward by a spring device (not shown).

The positional relationship between the air communication hole 725a and the ink supply opening 729a provided in the recording head 710, and the switching member 753a and the ink supply nozzle 752a provided in the ink supply mechanism 751a, is set as follows. That is, the recording head 710 and the ink supply mechanism 751a can be brought into the following states (7-1) to (7-4) by moving the ink supply mechanism 751a in the vertical direction through the driving force of the ink supply mechanism driving motor 113, when the carriage 711 (recording head 710) is located above the wiper and caps of the maintenance mechanism (given position).

(7-1) The slider 726a of the recording head 710 and the switching member 753a of the ink supply mechanism 751a are separated. The tank body 722a of the sub-tank 721a is communicated with the atmosphere via the air communication hole 725a and the communication hole 727a. The ink supply nozzle 752a of the ink supply mechanism 751a is not connected to the ink supply opening 729a of the recording head 710 (communication position, see FIG. 16).

(7-2) The slider 726a of the recording head 710 and the switching member 753a of the ink supply mechanism 751a are separated. The tank body 722a of the sub-tank 721a would otherwise be communicated with the atmosphere via the air communication hole 725a and the communication hole 727a. While the ink supply nozzle 752a of the ink supply mechanism 751a is not connected to the ink supply opening 729a of the recording head 710, the closing member 757a is abutted on the slider 726a so as to close the communication hole 727a (non-communication position, see FIG. 17A).

(7-3) The slider 726a of the recording head 710 is pressed by the switching member 753a (cam face 755a) of the ink supply mechanism 751a and is moved rearward. The tank body 722a of the sub-tank 721a is communicated with the atmosphere via the air communication hole 725a and the communication hole 727a. The ink supply nozzle 752a of the ink supply mechanism 751a is connected to the ink supply opening 729a that is communicated with the through hole 730a of the slider 726a so that ink can be supplied from the ink cartridge 21a to the sub-tank 721a (communication position, see FIG. 17B).

(7-4) The slider 726a of the recording head 710 is pressed by the switching member 753a (cam face 756a) of the ink supply mechanism 751a and is moved further rearward. The tank body 722a of the sub-tank 721a is no longer communicated with the atmosphere. The ink supply nozzle 752a of the ink supply mechanism 751a is connected to the ink supply opening 729a of the recording head 710 so that ink can be supplied from the ink cartridge 21a to the sub-tank 721a (communication position, see FIG. 18A).

[Description of Control Processor 70]

The control processor 70 moves the ink supply mechanisms 751a to 751d in the vertical direction by controlling the ink supply mechanism driving motor 113 via a driving circuit (not shown). The control processor 70 can bring the recording head 710 and the ink supply mechanisms 751a to 751d into the aforementioned states (7-1) to (7-4) by changing the relative position between the recording head 710 and the ink supply mechanisms 751a to 751d.

[Description of Operation of Ink Supply Mechanism 751a]

In the seventh embodiment as described above, the control processor 70 operates the ink supply mechanism 751a as follows.

During standby when the carriage 711 (recording head 710) is located above the wiper and caps of the maintenance mechanism (given position), the ink supply mechanism driving motor 113 is driven to move the ink supply mechanism 751a downward. The ink supply nozzle 752a is connected to the ink supply opening 729a, which is communicated with the through hole 730a of the slider 726a. The switching member 753a (cam face 755a) moves the slider 726a rearward against the biasing force of the spring device 728a, such that the air connection hole 725a is communicated with the atmosphere (ink supply position, see FIG. 17B, in FIGS. 17A and 17B, the end position of the ink supply mechanism 751a in the ink supply position is indicated by the reference symbol “C”). Even after the closing member 757a is abutted on the slider 726a, the ink supply mechanism 751a can be moved further downward due to the operation of a not shown spring device. In this case, ink can be supplied from the ink cartridge 21a to the sub-tank 721a of the recording head 710 by driving the pressurized pump 111 (see FIG. 16) (standby mode and ink supply mode, see FIGS. 17B and 18B).

Here, in order to store the ink inside the sub-tank 721a for a long period of time, the ink supply mechanism driving motor 113 is driven to move the ink supply mechanism 751a upward. The ink supply nozzle 752a is separated from the ink supply opening 729a. While the switching member 753a is also separated from the slider 726a, the closing member 757a is abutted on the slider 726a such that the communication hole 727a is closed (long-term storage position, see FIG. 17A, long-term storage mode, in FIGS. 17A and 17B, the end position of the ink supply mechanism 751a in the long-term storage position is indicated by the reference symbol “B”).

Now, in order to perform image recording onto a sheet, the ink supply mechanism motor 113 is driven to move the ink supply mechanism 751a upward. The ink supply nozzle 752a is separated from the ink supply opening 729a. The switching member 753a is also separated from the slider 726a (recording position, see FIG. 16, in FIG. 16, the end position of the ink supply mechanism 751a in the recording position is indicated by the reference symbol “A”). In this case, the ink supply opening 729a is sealed with an internal valve and the slider 726a also closes the top portion of the ink supply opening 729a, while the air communication hole 725a continues to be communicated with the atmosphere (recording (printing) mode, see FIGS. 16 and 18B). The carriage 711 is moved leftward by driving the carriage motor 30, and the aforementioned sheet end detection process and recording process are executed.

On the other hand, in order to recover the ink discharge performance of the recording head 710, the ink supply mechanism driving motor 113, when the carriage 711 (recording head 710) is above the wiper and the caps of the maintenance mechanism (given position), is driven to move the ink supply mechanism 751a further downward. The ink supply nozzle 752a is connected to the ink supply opening 729a. The switching member 753a (cam face 756a) moves the slider 726a rearward against the biasing force of the spring device 728a, such that the communication hole 727a of the slider 726a and the air communication hole 725a are no longer communicated (discharge performance recovery position, see FIG. 18A, in FIGS. 18A and 18B, the end position of the ink supply mechanism 751a at the discharge performance recovery position is indicated by the reference symbol “D”). Even after the ink supply nozzle 752a is connected to the ink supply opening 729a, the ink supply mechanism 751a can be moved further rearward due to the elasticity of packings 754a. In this case, ink can be supplied from the ink cartridge 21a to the sub-tank 721a of the recording head 710 by driving the pressurized pump 111 (see FIG. 16) (during discharge performance recovery (positive pressure purge), see FIGS. 18A and 18B). The ink discharge performance by the ink nozzle group 10a of the recording head 710 can be recovered by discharging ink from the ink nozzle group 10a.

[Effects]

According to the seventh embodiment, the sub-tank 721a can be sealed by closing the air communication hole 725a with the slider 726a being moved by the cam faces 755a, 756a of the switching member 753a. Therefore, in addition to achieving the effects in the sixth embodiment, the seventh embodiment can also cope with long-term storage, such as shipping, of the multifunctional apparatus.

### Other Embodiments

Embodiments of the present invention are described in the above. However, the present invention is not limited to the above described embodiments. The present invention can be practiced in various manners without departing from the technical scope of the invention.

For example, in the first embodiment, ink is supplied to the sub-tank 101a of the recording head 10 from the ink cartridge 21a by driving the pressurized pump 111. However, ink can be supplied to the sub-tank 101a of the recording head 10 from the ink cartridge 21a in other manners, e.g., by a pressurized device other than pumps.

What is claimed is:

1. An ink-jet recording apparatus comprising:
a recording head that has an internal sub-tank for storing ink, and records an image on a recording medium by ejecting ink inside the sub-tank from an injection nozzle;
a carriage that has the recording head mounted thereon, and can move to and fro in a direction orthogonal to a conveying direction of the recording medium;
a main tank that stores ink supplied to the sub-tank;
an ink supply member that supplies ink inside the main tank to the sub-tank;
a relative position changer that can change a relative position between the ink supply member and the sub-tank;
the sub-tank including
an ink supply opening that can be attached to/detached from the ink supply member and through which the ink inside the main tank is supplied, and
an air communication hole that communicates an inside of the sub-tank with the atmosphere,
the ink supply member including
an ink supply nozzle that can be attached to/detached from the ink supply opening, and
an open/close state switching member that switches an open/close state of the air communication hole,
a pressurized unit that applies pressure to the ink inside the main tank so as to deliver the ink inside the main tank to the ink supply member, and
a relative position controller that controls the relative position changer to switch an operation mode of the ink-jet recording apparatus to at least following three modes: (a) a recording mode in which the ink supply opening and the ink supply nozzle are separated and the air communication hole is in an open state so that recording of an image on the recording medium is enabled; (b) an ink supply mode in which the ink supply opening is connected to the ink supply nozzle and the air communication hole is in an open state so that ink is supplied to the sub-tank by pressure applied by the pressurized unit; and (c) a discharge performance recovery mode in which the ink supply opening and the ink supply nozzle are closely connected and the air communication hole is in a closed state so that discharge performance of the recording head is recovered by the pressure applied by the pressurized unit.

2. The ink-jet recording apparatus according to claim 1, wherein
the carriage can move to at least following three positions: (i) a recording position where image recording onto the recording medium is enabled; (ii) an ink supply position where ink is supplied to the sub-tank by the pressure applied by the pressurized unit; and (iii) a discharge performance recovery position where the discharge performance of the recording head is recovered, by to-and-fro motion of the carriage in the direction orthogonal to the conveying direction of the recording medium,
the relative position changer can change the relative position between the ink supply member and the sub-tank by moving the carriage to and fro in the direction orthogonal to the conveying direction of the recording medium,
the ink supply member, when the carriage is moved by the relative position changer to the recording position, brings the ink supply opening and the ink supply nozzle into a separated state and brings the air communication hole into an open state, when the carriage is moved by the relative position changer to the ink supply position, brings the ink supply opening and the ink supply nozzle into a connected state and brings the air communication hole into an open state, and when the carriage is moved by the relative position changer to the discharge performance recovery position, brings the ink supply opening and the ink supply nozzle into a closely connected state and brings the air communication hole into a closed state,
the relative position controller controls the relative position changer to move the carriage to (i) the recording position when the recording mode is selected, (ii) the ink supply position when the ink supply mode is selected, and (iii) the discharge performance recovery position when the discharge performance recovery mode is selected.

3. The ink-jet recording apparatus according to claim 1, wherein
the ink supply member can move to at least following three positions: (i) a recording position where the ink supply opening and the ink supply nozzle are brought into a separated state and the air communication hole is brought into an open state so that image recording onto the recording medium is enabled; (ii) an ink supply position where the ink supply opening and the ink supply nozzle are brought into a connected state and the air communication hole is brought into an open state so that ink is supplied to the sub-tank by the pressure applied by the pressurized unit; and (iii) a discharge performance recovery position where the ink supply opening and the ink supply nozzle are brought into a closely connected state and the air communication hole is brought into a closed state so that the discharge performance of the recording head is recovered, by being moved with respect to the carriage at a given position,
the relative position changer can change the relative position between the ink supply member and the sub-tank by moving the ink supply member with respect to the carriage at a given position,
the relative position controller controls the relative position changer to move the ink supply member to (i) the recording position when the recording mode is selected, (ii) the ink supply position when the ink supply mode is selected, and (iii) the discharge performance recovery position when the discharge performance recovery mode is selected.

4. The ink-jet recording apparatus according to claim 1, wherein
the sub-tank includes:
an air communication hole open/close member that can be moved between a communication position where the air communication hole is communicated with the atmosphere and a non-communication position where the air communication hole is not communicated with the atmosphere; and
a biasing device that biases the air communication hole open/close member to the communication position,
the open/close state switching member of the ink supply member is designed to separate from or abut on the air communication hole open/close member, by the relative position changer changing the relative position between the ink supply member and the sub-tank, so as to move the air communication hole open/close member between the communication position and the non-communication position.

5. The ink-jet recording apparatus according to claim 4, wherein
the open/close state switching member of the ink supply member has a cam face that is formed into a shape such that a distance moved by the air communication hole open/close member when abutted by the open/close state switching member differs depending on a moved position of the ink supply member.

6. The ink-jet recording apparatus according to claim 1, wherein
the open/close switching member of the ink supply member includes a switching member communication hole that communicates the air communication hole with the atmosphere, and is designed capable of being moved between a communication position where the air communication hole and the switching member communication hole are communicated so that the air communication hole is communicated with the atmosphere, and a non-communication position where the air communication hole and the switching member communication hole are not communicated so that the air communication hole is not communicated with the atmosphere, in accordance with a relative position between the sub-tank and the open/close state switching member.

7. The ink-jet recording apparatus according to claim 1, wherein
a valve is provided which seals the ink supply opening when the ink supply opening and the ink supply nozzle are in a separated state.

8. The ink-jet recording apparatus according to claim 7, wherein
the relative position controller can switch the operation mode of the ink-jet recording apparatus to a long-term storage mode in which the ink inside the sub-tank is stored for a long period of time, by controlling the relative position changer to bring the ink supply opening and the ink supply nozzle into a separated state and to bring the air communication hole into a closed state.
